(19) United States
(12) Patent Application Publication
(10) Pub. No.: US 2020/0241746 A1
(43) Pub. Date: Jul. 30, 2020

(54) MULTI-TASK MANAGEMENT METHOD AND TERMINAL DEVICE

(71) Applicant: HUAWEI TECHNOLOGIES CO., LTD., Shenzhen (CN)

(72) Inventors: Jian Chen, Hangzhou (CN); Min Ye, Shenzhen (CN); Jingyu Zhang, Shenzhen (CN)

(73) Assignee: HUAWEI TECHNOLOGIES CO., LTD., Shenzhen (CN)

(21) Appl. No.: 16/846,643

(22) Filed: Apr. 13, 2020

Related U.S. Application Data
(63) Continuation of application No. PCT/CN2018/091097, filed on Jun. 13, 2018.

(30) Foreign Application Priority Data
Oct. 23, 2017 (CN) 201710992026.2

(51) Int. Cl. G06F 3/0488; G06F 9/48; H04M 1/725

(52) U.S. Cl. CPC G06F 3/04886; G06F 3/04883; H04M 1/72583; G06F 9/4843

(57) ABSTRACT

A terminal device is provided. The terminal device is configured to detect a trigger instruction used to trigger display of one or more preset running user interfaces that respectively correspond to at least one application run in a background; and display a running user interface list in a first area of a display screen after detecting the trigger instruction, where the running user interface list includes the one or more preset running user interfaces that respectively correspond to the at least one application. According to the method provided in this application, a user can view, by using a multi-task management user interface, a running state of an application run in a background without switching the application run in the background into a foreground.

### CROSS-REFERENCE TO RELATED APPLICATIONS

This application is a continuation of International Application No. PCT/CN 2018/091097, filed on Jun. 13, 2018, which claims priority to Chinese Patent Application No. 201710992026.2, filed on Oct. 23, 2017, the disclosures of the aforementioned applications are hereby incorporated by reference in their entireties.

### TECHNICAL FIELD

This application relates to the field of terminal device technologies, and in particular, to a multi-task management method and a terminal device.

### BACKGROUND

Currently, terminal devices, such as mobile phones and tablet computers, are widely used by users because they can be simply operated and have diverse functions.

In the prior art, the foregoing terminal device supports only running of a current application in a foreground, and when a user opens a new application, the user needs to switch the application from previously being run in the foreground to being run in a background. For applications that are run in the background, the user may quickly and effectively switch the applications by using a multi-task management function of the terminal device, and quickly release system memory of the terminal device by closing the applications currently run in the background, thereby improving processing efficiency of the terminal device.

There are a plurality of multi-task management forms for an existing terminal device, and two common multi-task management forms are as follows:

FIG. 1 shows a multi-task management form. Referring to FIG. 1, when an application that is run in a foreground is switched to into a background for running, a screenshot of a last frame of image of the application is retained. Screenshots of images corresponding to applications that are switched into the background for running are tiled or cascaded in a form of cards on a multi-task management user interface. After triggering multi-task management, a user may view the applications that are run in the background by sliding the corresponding cards leftward or rightward. If the user wants to interact with an application on the multi-task management user interface, the user needs to switch the corresponding application into the foreground by clicking a corresponding card, and the user may alternatively close an application run in the background by sliding a corresponding card upward or downward out of a display area of a display screen.

FIG. 2 shows another multi-task management form. Referring to FIG. 2, when an application that is run in a foreground is switched to into a background for running, a screenshot of a last frame of image of the application is retained. Screenshots of images corresponding to applications that are switched into the background for running are switched into the background for running are tiled or cascaded in a form of cards on a multi-task management user interface. After triggering multi-task management, a user may view the applications that are run in the background by sliding the corresponding cards upward or downward. If the user wants to interact with an application on the multi-task management user interface, the user needs to switch the corresponding application into the foreground by clicking a corresponding card, and the user may alternatively close an application run in the background by sliding a corresponding card leftward or rightward out of a display area of a display screen. A button for closing all applications is further provided on the multi-task management user interface. All the applications that are run in the background may be cleared up by clicking the button.

In the prior art, a single function is provided by the multi-task management of the terminal device, and application scenarios are relatively limited. As described above, the multi-task management can only be used to switch or close a plurality of applications that are run in the background, and functions of some common application scenarios cannot be implemented by using the existing multi-task management. For example, if a user wants to open another application in the foreground after pre-hailing a vehicle by using a vehicle hailing application, the user needs to switch the vehicle hailing application into the background for running and run the other application in the foreground. If the user wants to view a current location of the pre-hailed vehicle, the user needs to switch the application run in the foreground to the vehicle hailing application. After the vehicle hailing application is switched into the foreground, the terminal device updates, to latest content, a screenshot of a last frame of image obtained when the vehicle hailing application is switched into the background, so that the user can view the current location of the pre-hailed vehicle. After viewing the current location of the pre-hailed vehicle, the user switches the vehicle hailing application to the application previously run in the foreground and continues to use the application. In this way, operations of frequent application switching are complex and have low efficiency. In addition, the application switching requires a specific waiting time, and a specific update time is required when the screenshot of the last frame of image is updated to the latest content for the vehicle hailing application that is switched into the foreground. Consequently, the user waits for a relatively long time, and user experience is affected. Obviously, the existing multi-task management cannot be well applied to some application scenarios.

### SUMMARY

Embodiments of this application provide a multi-task management method, to resolve a problem that existing multi-task management affects user experience and cannot be relatively well applied to some application scenarios because a specific waiting time is required when an application is switched between a foreground and a background.

According to a first aspect, an embodiment of this application provides a multi-task management method. The method includes: detecting, by a terminal device, a trigger instruction used to trigger display of one or more preset running user interfaces that respectively correspond to at least one application run in a background; and displaying a running user interface list in a first area of a display screen after detecting the trigger instruction, where the running user interface list includes the one or more preset running user interfaces that respectively correspond to the at least one application.

The first area of the display screen may be a partial display area of the display screen, or may be an entire display area of the display screen. This is not limited in this application.

It should be noted that, the preset running user interface may be a running user interface customized by a user for an application. If the user does not define the user interface for the application, the preset running user interface may be, by default, a last user interface before the application is switched into the background for running or a home page user interface of the application.

According to the foregoing method, the terminal device displays, on a multi-task management user interface, the one or more preset running user interfaces that respectively correspond to the at least one application run in the background. Compared with a prior-art method in which the terminal device displays, on the multi-task management user interface, a screenshot of a last frame of image obtained when the at least one application run in the background is switched into the background for running, according to the multi-task management method provided in this embodiment of this application, a user can close or switch, by using the multi-task management user interface, an application run in the background, and can also view, by using the multi-task management user interface, running states of a plurality of applications that are run in the background, so that the multi-task management method can be relatively well applied to application scenarios in addition to switching or closing the application. The multi-task management method provided in this embodiment of this application has a relatively high practical value for a scenario in which a user needs to control a running state of a background application. For example, a user is currently watching a video by using the terminal device, but the user has previously pre-hailed a vehicle by using a vehicle hailing application in the terminal device, pre-ordered a meal by using a takeout application, and also opened a chat application to have a chat. If the user wants to view a current location of the pre-hailed vehicle, view a current location of a delivery worker, or view current chat content in the chat application, according to the existing multi-task management method, the user must first switch the application from being run in the background to being run in the foreground, and update a user interface corresponding to the application switched into the foreground for running to a current running user interface from a screenshot of a last frame of image obtained when the application is switched into the background for running. The operations are relatively complex, efficiency is low, the user waits for a relatively long time; and consequently, user experience is severely affected. However, according to the multi-task management method provided in this embodiment of this application, the user can view running states of the vehicle hailing application, the takeout application, and the chat application by using a running user interface list without switching the vehicle hailing application, the takeout application, and the chat application into the foreground for running, so that an application switching time and an application update time can be reduced, thereby further reducing a waiting time of the user and improving user experience.

In a possible design, an operation icon control is displayed on at least one preset running user interface included in the one or more preset running user interfaces that respectively correspond to the at least one application; and after the terminal device displays the running user interface list in the first area of the display screen, if detecting that an operation icon control on any one of the at least one preset running user interface is triggered, the terminal device performs an operation corresponding to the operation icon control on an application corresponding to the preset running user interface on which the operation icon control is triggered.

The operation icon control is used to trigger performing of an operation corresponding to the operation icon control.

According to the foregoing method, the user can switch and close, by using a multi-task management user interface, an application run in the background, and view a running state of the application run in the background, and can also interact with the application run in the background. An application corresponding to an operation icon control is triggered by triggering the operation icon control, to perform an operation corresponding to the operation icon control, so that scenarios to which multi-task management is applicable are further enriched. For example, it is assumed that three operation icon controls are set for a music application run in the background, and the three operation icon controls are respectively an operation icon control for controlling music playing and pausing, an operation icon control for controlling switching to a previous song, and an operation icon control for controlling switching to a next song. If the user is currently in a chat by using the chat application, but wants to switch to a previous song of the music application run in the background, according to the multi-task management method provided in this embodiment of this application, the user may trigger an operation icon control for controlling switching to a previous song on a preset running user interface that corresponds to the music application and that is displayed in the first area of the display screen, to directly switch to playing the previous song without switching the music application into the foreground for running as in the prior art. The operation is simple, and the waiting time of the user can be reduced.

In a possible design, the terminal device may display, in the first area of the display screen, the running user interface list including the one or more preset running user interfaces that respectively correspond to the at least one application without detecting the trigger instruction used to trigger display of the one or more preset running user interfaces that respectively correspond to the at least one application run in the background. To be specific, in this embodiment of this application, display of the one or more preset running user interfaces that respectively correspond to the at least one application may be triggered by using the instruction. Alternatively, the one or more preset running user interfaces that respectively correspond to the at least one application are directly displayed on the display screen of the terminal device without triggering, by using the instruction, display of the one or more preset running user interfaces that respectively correspond to the at least one application. In this way, it is very convenient for a new user who is not familiar with multi-task management. In an actual application, whether the one or more preset running user interfaces that respectively correspond to the at least one application need to be displayed through triggering of the trigger instruction needs to be flexibly set as required.

In a possible design, after displaying, in the first area of the display screen, the running user interface list including the one or more preset running user interfaces that respectively correspond to the at least one application, the terminal device obtains, at a preset first period, one or more pieces of next moment running data respectively corresponding to the at least one application, determines, based on the one or more pieces of next moment running data respectively corresponding to the at least one application, one or more next moment preset running user interfaces that respectively correspond to the at least one application, and correspondingly updates one or more current preset running user interfaces of the at least one application respectively by using the one or more next moment preset running user interfaces that respectively correspond to the at least one application.

According to the foregoing method, the terminal device may update, in real time, the one or more preset running user interfaces that respectively correspond to the at least one application, so that the user can view, based on the multi-task management user interface, a dynamic running process of the at least one application run in the background. For example, when the user is currently opening a reading application for reading, and the user has previously opened the music application for playing a song, if the user wants to view a music playing process, according to the existing multi-task management method, the user needs to switch the music application from being run in the background to being run in the foreground. However, according to the multi-task management method provided in this embodiment of this application, the user can view a dynamic running process of the music application in the first area of a display screen without switching the music application into the foreground for running, so that a waiting time of the user can be reduced, and user experience can be improved.

In a possible design, the terminal device displays, in a second area of the display screen, a running user interface of an application currently run in a foreground or displays a desktop user interface of the terminal device. For example, if the terminal device has an application run in the foreground, the application run in the foreground is displayed in the second area of the display screen; or if the terminal device does not have an application run in the foreground, the desktop user interface of the terminal device is displayed in the second area of the display screen. In this design, the first area is a partial area of the display screen.

The second area of the display screen may be an area on the display screen other than the first area.

According to the foregoing method, when a user manages (for example, switches, views, or closes) an application run in the background, an application run in the foreground is not affected, and a requirement of the user for simultaneously using a plurality of applications may be satisfied. For example, if the user is currently viewing a video by using a video application, according to the multi-task management method provided in this embodiment of this application, the user may view, in the first area of the display screen, a running state of the chat application run in the background without affecting the video application that is being currently viewed. However, this cannot be implemented by using the existing multi-task management method.

In a possible design, the one or more preset running user interfaces that respectively correspond to the at least one application are of a preset shape. The preset shape is not limited in this embodiment of this application. For example, a preset running user interface corresponding to a music-type application may be set as a circle, so that when a playing user interface is run in the music application, a compact disc user interface with which the user is most concerned can be displayed on the circular preset running user interface. In this way, even if the music application is run in the background, an animation effect of a rotating compact disc makes the user feel, in terms of visual experience, that the music application is run in the foreground. A preset running user interface corresponding to an application of another type may further be set as a rectangle. Certainly, the circle or rectangle may alternatively be another shape.

In a possible design, after displaying the running user interface list in the first area of the display screen, the terminal device scales down or up a size of the first area when detecting an instruction used to trigger scaling down or up of the first area.

According to the foregoing method, the user can flexibly change the size of the first area displaying the one or more preset running user interfaces that respectively correspond to the at least one application, to adapt to different application scenarios.

In a possible design, the scaling down or up, by the terminal device, a size of the first area specifically includes: scaling down, by the terminal device, the size of the first area, and scaling down, based on a scale-down ratio of the first area by the scale-down ratio, the one or more preset running user interfaces that respectively correspond to the at least one application and that are displayed in the first area. Certainly, the terminal device may alternatively scale down, not based on the scale-down ratio of the first area, the one or more preset running user interfaces that respectively correspond to the at least one application. Alternatively, the terminal device scales up the size of the first area, and scales up, based on a scale-up ratio of the first area by the scale-up ratio, the one or more preset running user interfaces that respectively correspond to the at least one application and that are displayed in the first area. Certainly, the terminal device may scale up, not based on the scale-up ratio of the first area, the one or more preset running user interfaces that respectively correspond to the at least one application. In this embodiment of this application, a ratio by which the one or more preset running user interfaces that respectively correspond to the at least one application are scaled down or up based with the first area is not limited.

According to the foregoing method, the user may scale down or up, as required, the one or more preset running user interfaces that respectively correspond to the at least one application. For example, if the user wants to view more content related to the running user interface, the user may scale up the size of the first area, to further scale up the preset running user interface corresponding to the application. Compared with the existing multi-task management method in which applications that are run in the background are displayed in an entire area of the display screen of the terminal device, according to the method provided in this embodiment of this application, the user can flexibly adjust the size of the first area displaying the one or more preset running user interfaces that respectively correspond to the at least one application, to adapt to different application scenarios, so that user experience is relatively good.

In this embodiment of this application, the terminal device may display the running user interface list in the first area of the display screen in a plurality of manners. In a possible design, the terminal device displays the running user interface list in the first area of the display screen in a tiled or cascaded manner. In another possible design, the terminal device completely displays, in the first area of the display screen, content included in a first part of the preset running user interfaces included in the running user interface list, and partially displays content included in a second part of the preset running user interfaces included in the running user interface list, where the first part of the preset running user interfaces is different from the second part of the preset running user interfaces.

It should be noted that, a sum of a quantity of the running user interfaces of the first part and a quantity of the running user interfaces of the second part may be equal to a quantity of all the preset running user interfaces included in the running user interface list, or certainly may be less than a quantity of all the preset running user interfaces included in the running user interface list. When the sum of the quantity of the preset running user interfaces of the first part and the quantity of the preset running user interfaces of the second part is less than the quantity of all the preset running user interfaces included in the running user interface list, a remaining preset running user interface that is not displayed in the first area may be hidden in the terminal device, and may be displayed through triggering of an instruction.

According to the foregoing method, the terminal device can flexibly select a manner of displaying the one or more preset running user interfaces that respectively correspond to the at least one application, so that the multi-task management of the terminal device is applicable to more application scenarios. For example, when the user is concerned with only an application A and an application B included in the at least one application, it is feasible to completely display, in the first area of the display screen, content included in preset running user interfaces that correspond to the application A and the application B and that are included in the one or more preset running user interfaces that respectively correspond to the at least one application, and partially display content included in a preset running user interface corresponding to an application, other than the application A and the application B, included in the one or more preset running user interfaces that respectively correspond to the at least one application. Certainly, the preset running user interface corresponding to the application, other than the application A and the application B, may alternatively be hidden.

In a possible design, when detecting a viewing instruction used to trigger viewing of the second part of the preset running user interfaces, the terminal device completely displays the content included in the second part of the preset running user interfaces. The user may conveniently switch the partially displayed preset running user interfaces to the completely displayed preset running user interfaces by using the trigger instruction, to satisfy a requirement of the user for complete display of the preset running user interface.

A viewing instruction for triggering viewing of a partially displayed preset running user interface may be sliding the partially displayed preset running user interface leftward or rightward or sliding the partially displayed preset running user interface upward or downward. This is not limited in this embodiment of this application.

In a possible design, after displaying the running user interface list in the first area of the display screen, if detecting a trigger instruction used to trigger running of any application of the at least one application in the foreground, the terminal device switches the application into the foreground for running; and displays, in an entire area of the display screen, the first area of the display screen, or the second area of the display screen, a first running user interface corresponding to the application that is switched into the foreground for running.

It should be noted that, the first running user interface is different from the preset running user interface, and the first running user interface is not a running user interface customized by the user for the application but is a conventional running user interface of the application when the application is run in the foreground. Specifically, the preset running user interface may display partial content during running of the application as set by the user, and the first running user interface displays entire content during running of the application.

According to the foregoing method, the user may conveniently switch, by using the running user interface list, an application from being run in the background to being run in the foreground, and the application may be displayed in the entire area of the display screen or may be displayed in the first area or the second area of the display screen, to satisfy various requirements of the user, so that user experience is improved.

According to a second aspect, an embodiment of this application provides a terminal device. The terminal device has a function of implementing a behavior of the terminal device in the foregoing method example in the first aspect. The function may be implemented by using hardware, or may be implemented by hardware executing corresponding software. The hardware or software includes one or more modules corresponding to the foregoing function.

In a possible design, the terminal device includes a transceiver unit, a processing unit, and a display unit. These units can perform corresponding functions in the foregoing method example in the first aspect. For details, refer to detailed descriptions in the method example, and details are not described herein again.

According to a third aspect, an embodiment of this application provides a terminal device. The terminal device has a function of implementing a behavior of the terminal device in the foregoing method example in the first aspect. The function may be implemented by using hardware.

In a possible design, a structure of the terminal device includes a processor, a memory, a display screen, an input/output interface, and a bus. The processor, the memory, the display screen, and the input/output interface are connected by using the bus. The processor invokes an instruction stored in the memory, to perform the foregoing method. The display screen is configured to display the one or more preset running user interfaces that respectively correspond to the at least one application.

According to a fourth aspect, an embodiment of this application further provides a computer storage medium. The computer storage medium stores a computer executable instruction, and when the computer executable instruction is invoked by a computer, the computer is enabled to perform the method according to any one of the first aspect or the designs of the first aspect.

According to a fifth aspect, an embodiment of this application further provides a computer program product. The computer program product stores an instruction, and when the instruction is run on a computer, the computer is enabled to perform the method according to any one of the first aspect or the possible designs of the first aspect.

In the solutions provided in the embodiments of this application, the terminal device displays, on the multi-task management user interface, the one or more preset running user interfaces that respectively correspond to the at least one application run in the background. Compared with a prior-art method in which the terminal device displays, on the multi-task management user interface, a screenshot of a last frame of image obtained when the at least one application is switched into the background, according to the method provided in the embodiments of this application, a user can close or switch, by using the multi-task management user interface, an application run in the background, and can also view, by using the multi-task management user interface, a running state of the application run in the background, so that the multi-task management method can be relatively well applied to application scenarios in addition to switching or closing the application, and the multi-task management method has a relatively high practical value for a scenario in which a user needs to control a running state of a background application.

### BRIEF DESCRIPTION OF DRAWINGS

FIG. 1 is an existing multi-task management form;

FIG. 2 is another existing multi-task management form;

FIG. 3 is a schematic structural diagram of a mobile phone according to this application;

FIG. 4 is a flowchart of a multi-task management method according to this application;

FIG. 5A is a schematic diagram of a manner of triggering display of a multi-task management user interface according to this application;

FIG. 5B is a schematic diagram after display of the multi-task management user interface is triggered according to this application;

FIG. 6A is a schematic diagram of displaying a running user interface list according to this application;

FIG. 6B is another schematic diagram of displaying a running user interface list according to this application;

FIG. 6C is still another schematic diagram of displaying a running user interface list according to this application;

FIG. 6D is still another schematic diagram of displaying a running user interface list according to this application;

FIG. 7A is a schematic diagram of displaying an operation icon control according to this application;

FIG. 7B is a schematic diagram of a manner of triggering an operation icon control according to this application;

FIG. 7C is a schematic diagram after an operation icon control is triggered according to this application;

FIG. 7D is a schematic diagram of displaying an application in a foreground according to this application;

FIG. 7E is a schematic diagram of displaying a preset running user interface corresponding to an application according to this application;

FIG. 8A is still another schematic diagram of displaying an operation icon control according to this application;

FIG. 8B is still another schematic diagram of displaying an operation icon control according to this application;

FIG. 9A is a schematic diagram of a manner of triggering scaling up of a first area according to this application;

FIG. 9B is a schematic diagram after scaling up of the first area is triggered according to this application;

FIG. 9C is another schematic diagram of a manner of triggering scaling up of a first area according to this application;

FIG. 9D is another schematic diagram after scaling up of the first area is triggered according to this application;

FIG. 10A is a schematic diagram of running a preset running user interface in a foreground according to this application;

FIG. 10B is another schematic diagram of running a preset running user interface in a foreground according to this application;

FIG. 10C is still another schematic diagram of running a preset running user interface in a foreground according to this application;

FIG. 11A is a schematic diagram of a music list user interface according to this application;

FIG. 11B is a schematic diagram of a music playing user interface according to this application;

FIG. 12 is a schematic structural diagram of a terminal device according to this application; and

FIG. 13 is a schematic structural diagram of another terminal device according to this application.

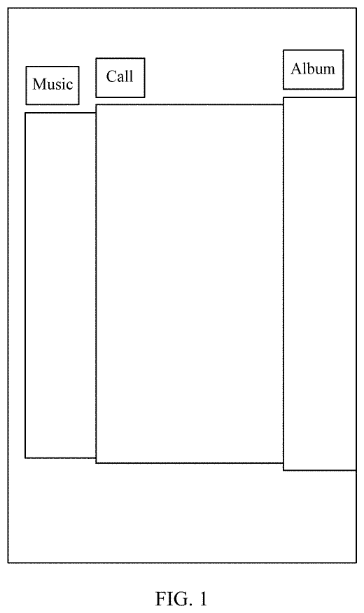

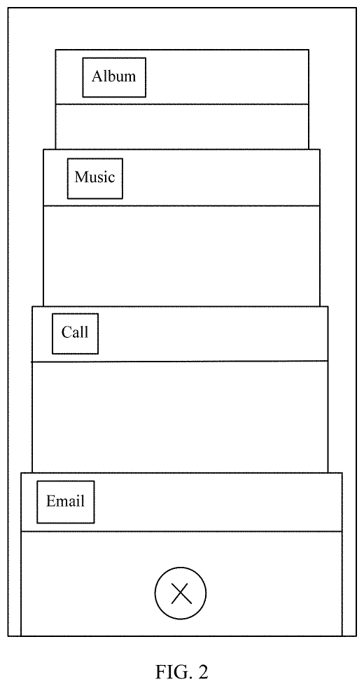

### DESCRIPTION OF EMBODIMENTS

Embodiments of this application provide a multi-task management method and a terminal device, to resolve a problem that existing multi-task management affects user experience and cannot be relatively well applied to some application scenarios because a specific waiting time is required when an application is switched between a foreground and a background.

Some terms of the embodiments of this application are first described, to help persons skilled in the art have a better understanding.

1. Terminal device: The terminal device may include a mobile phone, a tablet computer, a notebook computer, a personal digital assistant (personal digital assistant, PDA), a point of sales (point of sales, POS), an in-vehicle computer, a smart watch, a television, another electronic device having a display screen, and the like.

2. Multi-task management: The multi-task management is a function of the terminal device. The function can help a user to switch between an application run in a background and an application run in a foreground, and can help the user to clear up the application run in the background.

3. Multi-task management user interface: Once a user triggers the multi-task management function of the terminal device, a user interface is displayed, and the user interface is usually referred to as a multi-task management user interface.

4. Application run in a foreground: The application run in the foreground refers to an application that is run in the terminal device and that is displayed in an interaction user interface between the terminal device and a user.

5. Application run in a background: The application run in the background refers to an application that is run in the terminal device and that is not displayed in an interaction user interface between the terminal device and a user.

6. A desktop user interface of the terminal device: The desktop user interface of the terminal device is an interaction user interface between the terminal device and a user when no application is run in the foreground of the terminal device.

To make the objectives, technical solutions, and advantages of this application clearer, the following further describes this application in detail with reference to the accompanying drawings.

The multi-task management method provided in the embodiments of this application can be applied to various terminal devices. The terminal device includes, but is not limited to, a personal computer, a server computer, a handheld or laptop device, a mobile device (such as a mobile phone, a tablet computer, a PDA, or a media player), a consumption-based electronic device, an in-vehicle computer, a smart watch, a television, another terminal device having a display screen, and the like.

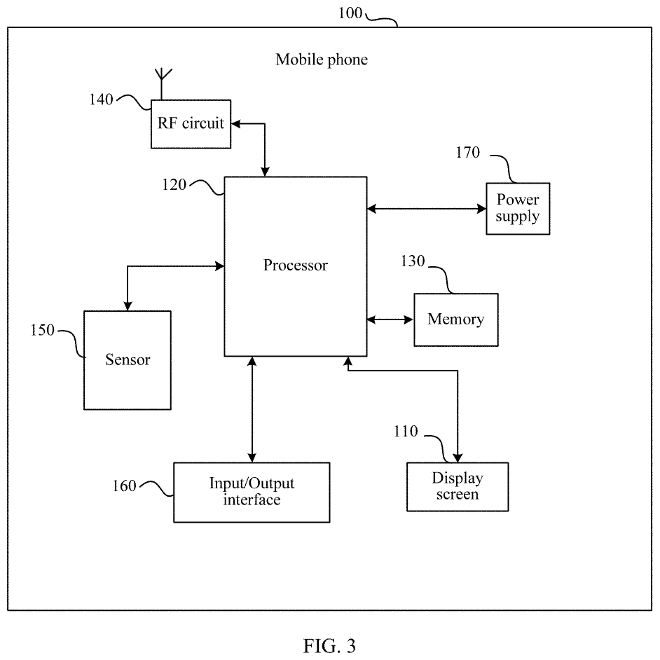

A specific implementation process in this embodiment of the present invention is described below in detail by using a mobile phone as an example. Specific structure compositions of the mobile phone are described below first, and details are shown in FIG. 3.

FIG. 3 is a schematic structural diagram of hardware of a mobile phone to which an embodiment of this application is applied. As shown in FIG. 3, a mobile phone 100 includes a display screen 110, a processor 120, and a memory 130. The memory 130 may be configured to store a computer program and data. The processor 120 performs various functions and data processing of the mobile phone 100 by running or executing a software program and/or data stored in the memory 130. The memory 130 may mainly include a program storage area and a data storage area. The program storage area may store an operating system, an application program required by at least one function, and the like. The data storage area may store data (such as audio data, an address book, and image data) created based on use of the mobile phone 100, and the like. In addition, the memory 130 may include a high speed random access memory, and may further include a non-volatile memory such as at least one magnetic disk storage device, a flash memory, or another volatile solid-state storage device. The processor 120 is a control center of the mobile phone 100, is connected to various parts of the entire mobile phone by using various interfaces and lines, and performs the various functions and the data processing of the mobile phone 100 by running or executing software program and/or the data stored in the memory 130, thereby performing overall monitoring on the mobile phone. The processor 120 may include one or more general-purpose processors, may further include one or more digital signal processors (digital signal processor, DSP), and may further include one or more image signal processors (image signal processor, ISP), to perform related operations to implement the technical solutions provided in the embodiments of this application.

The display screen 110 is configured to display information input by a user or information provided for the user, various menu user interfaces of the mobile phone 100, and the like. In the embodiments of this application, the display screen 110 is mainly configured to display a current running user interface of an application run in a foreground of the mobile phone 100, a preset running user interface of an application run in a background, or a desktop user interface of the mobile phone 100. Optionally, the display screen 110 may be configured in a form such as a liquid crystal display (liquid crystal display, LCD) or an OLED (organic light-emitting diode, organic light-emitting diode).

The mobile phone 100 may further include a radio frequency (radio frequency, RF) circuit 140. The RF circuit 140 may be configured to send and receive a signal during an information sending and receiving process or a call process. Usually, the RF circuit 140 includes, but is not limited to, an antenna, at least one amplifier, a transceiver, a coupler, a low noise amplifier (low noise amplifier, LNA), a duplexer, and the like.

The mobile phone 100 may further include one or more sensors 150, for example, an image sensor, an optical sensor, and a motion sensor.

The mobile phone 100 may further include an input/output interface 160, configured to: receive input digit information, character information, or a contact-type touch operation/non-contact-type gesture, and generate a signal input related to a user setting and function control of the mobile phone 100, and the like. Specifically, the input/output interface 160 may include, but is not limited to, one or more of a physical keyboard, a functional key (such as a volume control key or a switch key), a touchscreen, and the like.

In addition, the mobile phone 100 further includes a power supply 170 (such as a battery) for supplying power to the components. The power supply may be logically connected to the processor 120 by using a power management system, thereby implementing functions such as charging, discharging, and power consumption management by using the power management system.

Certainly, based on a requirement in a specific application, the foregoing mobile phone 100 may further include a camera, an audio circuit, a speaker, and the like. The components are not components mainly used in the embodiments of this application. Therefore, the components are not shown in FIG. 3, and details are not described again.

Based on the foregoing descriptions, this application provides a multi-task management method and a terminal device, to resolve a problem that existing multi-task management affects user experience and cannot be relatively well applied to some application scenarios because a specific waiting time is required when an application is switched between a foreground and a background. The method and the device are based on a same inventive concept. Principles of the method and the device in resolving the problem are similar. Therefore, implementations of the device and the method may be mutually referred to, and repetitions are not described.

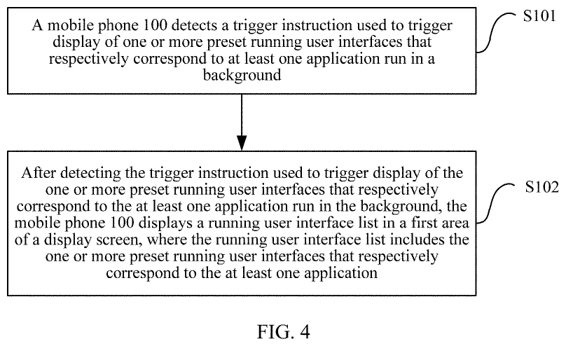

In the embodiments of this application, descriptions are provided by using an example in which the terminal device is the mobile phone 100. However, the embodiments of this application are not limited from being applied to terminal devices of other types. Referring to FIG. 4, a specific procedure of the method may include the following steps.

S101: The mobile phone 100 detects a trigger instruction used to trigger display of one or more preset running user interfaces that respectively correspond to at least one application run in a background.

In this embodiment of this application, the mobile phone 100 may input, by using the input/output interface 160, the trigger instruction used to trigger display of the one or more preset running user interfaces that respectively correspond to the at least one application run in the background, and detect, by using the processor 120, the trigger instruction that is input by using the input/output interface 160 and that is used to trigger display of the one or more preset running user interfaces that respectively correspond to the at least one application run in the background.

S102: After detecting the trigger instruction used to trigger display of the one or more preset running user interfaces that respectively correspond to the at least one application run in the background, the mobile phone 100 displays a running user interface list in a first area of the display screen, where the running user interface list includes the one or more preset running user interfaces that respectively correspond to the at least one application.

In this embodiment of this application, after detecting, by using the processor 120, the trigger instruction used to trigger display of the one or more preset running user interfaces that respectively correspond to the at least one application run in the background, the mobile phone 100 may further control, by using the processor 120, displaying the running user interface list in the first area of the display screen 110. The first area of the foregoing display screen 110 may be a partial display area of the display screen 110, or may be an entire display area of the display screen 110. This is not limited in this application.

It should be noted that, in this embodiment of this application, the preset running user interface may be a running user interface customized by a user for an application. For example, a music application includes a music list user interface, a music playing user interface, and a home page user interface of the music application. The user may customize a preset running user interface as the music playing user interface for the music application. If the user does not define a user interface for the application, the preset running user interface may be, by default, a last user interface before the application is switched into the background for running or a home page user interface of the application.

If the first area is a partial display area of the display screen 110, the mobile phone 100 may display, in a second area of the display screen 110, a running user interface of an application currently run in a foreground or display a desktop user interface of the mobile phone 100. For example, if the mobile phone 100 has an application run in the foreground currently, the running user interface of the application currently run the foreground is displayed in the second area of the display screen 110. If the mobile phone 100 has no application run in the foreground currently, the desktop user interface of the mobile phone 100 is displayed in the second area of the display screen 110. The second area of the display screen 110 may be an area on the display screen 110 other than the first area. According to the method, when a user manages (for example, switches, views, or closes) an application run in the background, an application run in the foreground is not affected, and a requirement of the user for simultaneously using a plurality of applications may be satisfied. For example, if the user is currently viewing a video by using a video application, according to the multi-task management method provided in this embodiment of this application, the user may view, in the first area of the display screen 110, a running state of a chat application run in the background without affecting the video application that is being currently viewed. However, an existing multi-task management method cannot be applied to the foregoing application scenario.

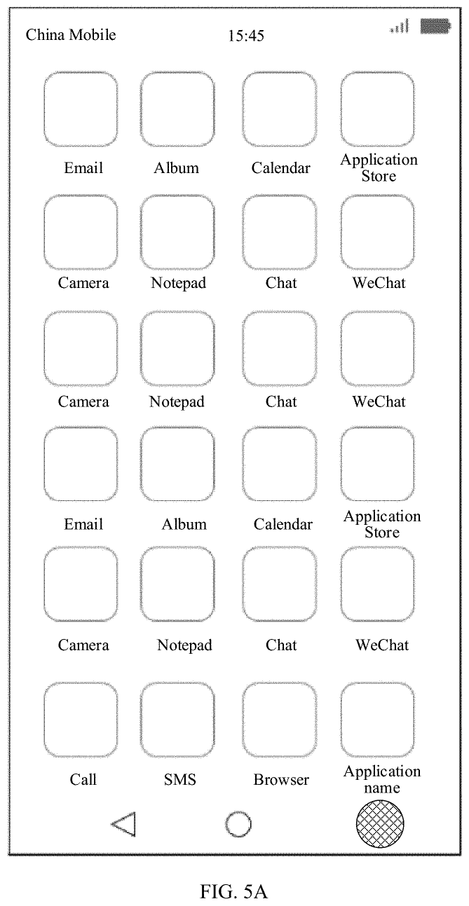

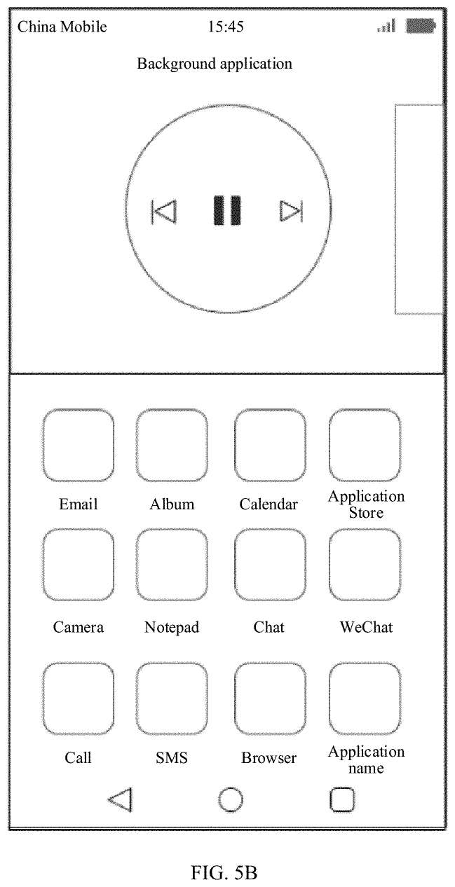

In an implementation of FIG. 4, the user needs to trigger a multi-task management function of the mobile phone 100 by using an instruction. FIG. 5A shows a manner of triggering display of one or more preset running user interfaces corresponding to the at least one application. The user may trigger display of a multi-task management user interface by clicking a corresponding trigger button “ε”. Certainly, the user may alternatively trigger display of the multi-task management user interface by using other gestures or sound. FIG. 5B is a schematic diagram after the user triggers display of the multi-task management user interface. FIG. 5B shows a case in which the first area occupies a partial area of the display screen 110. In this case, the desktop user interface of the mobile phone 100 or a running user interface corresponding to an application running in a foreground of the mobile phone 100 may be displayed in an area on the display screen 110 other than the first area. In another possible implementation, the mobile phone 100 may display, in the first area of the display screen 110, the running user interface list including the one or more preset running user interfaces that respectively correspond to the at least one application without detecting the trigger instruction used to trigger display of the one or more preset running user interfaces that respectively correspond to the at least one application run in the background. In this embodiment of this application, the multi-task management function of the mobile phone 100 may be triggered by using an instruction, or the multi-task management function of the mobile phone 100 may be triggered without using an instruction. This is not limited in this application. An implementation of triggering the multi-task management function of the mobile phone 100 without using an instruction is relatively convenient for a new user who is not familiar with multi-task management. In a specific implementation, whether the one or more preset running user interfaces that respectively correspond to the at least one application need to be displayed through triggering of the trigger instruction needs to be flexibly set as required.

Compared with the prior-art method in which a screenshot of a last frame of image is displayed on the multi-task management user interface when the at least one application is switched into the background, according to the multi-task management method provided in this embodiment of this application, the mobile phone 100 displays, on the multi-task management user interface, the one or more preset running user interfaces that respectively correspond to the at least one application run in the background, so that the user can view a running state of a background application without switching the application from the background to the foreground, so that an application switching time and an application update time can be reduced, a waiting time of the user can be further reduced, and user experience is improved. Further, a user can close or switch, by using the multi-task management user interface, an application run in the background, and can also view, by using the multi-task management user interface, a running state of an application run in the background, so that scenarios to which the multi-task management function is applicable are enriched. Specifically, the multi-task management method provided in this embodiment of this application has a specific practical value for a scenario in which a user needs to control a running state of a background application. For example, a user is currently watching a video by using the mobile phone 100, but the user has previously pre-hailed a vehicle by using a vehicle hailing application in the mobile phone 100, pre-ordered a meal by using a takeout application, and also opened a chat application to have a chat. If the user wants to view a current location of the pre-hailed vehicle, view a current location of a delivery worker, or view current chat content in the chat application, according to the existing multi-task management method, the user must first switch the application from being run in the background to being run in the foreground, and update a user interface of the application run in the foreground to a current running user interface from a screenshot of a last frame of image obtained when the application is switched into the background for running. The operations are relatively complex, efficiency is low, the user waits for a relatively long time, and user experience is severely affected. However, according to the multi-task management method provided in this embodiment of this application, the user can view running states of the vehicle hailing application, the takeout application, and the chat application without switching the vehicle hailing application, the takeout application, and the chat application from being run in the background to being run in the foreground, so that the operation is easy and efficiency is high.

In this embodiment of this application, a manner of displaying, by the mobile phone 100, the running user interface list in the first area of the display screen 110 is not limited. Two displaying manners of displaying the running user interface list in the first area of the display screen 110 are described below:

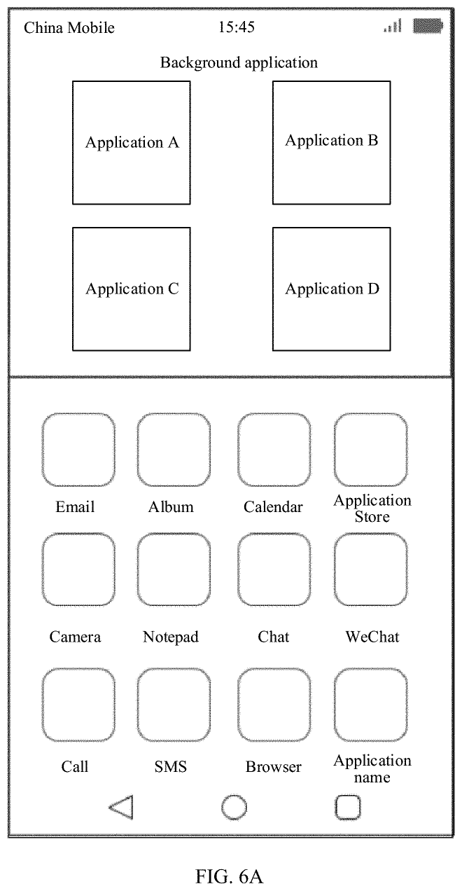

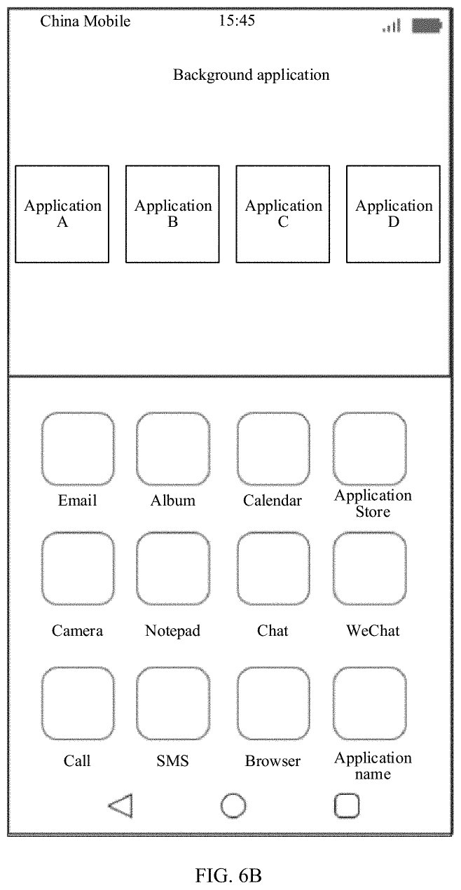

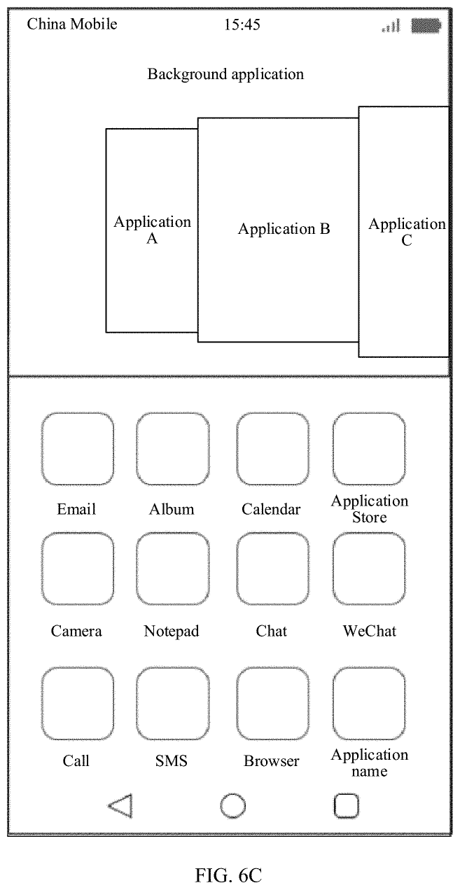

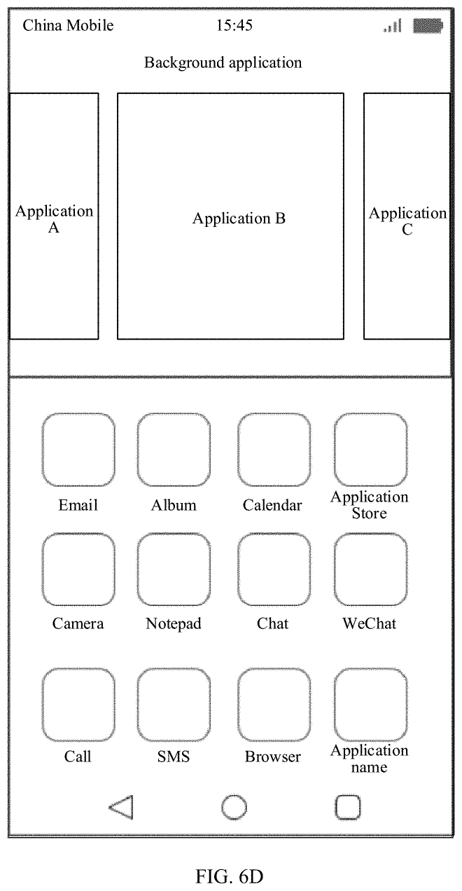

Manner 1: The mobile phone 100 displays the running user interface list in the first area of the display screen 110 in a tiled or cascaded manner. Referring to FIG. 6A and FIG. 6B, the mobile phone 100 in FIG. 6A and FIG. 6B displays the running user interface list in the tiled manner, and the running user interface list includes preset running user interfaces respectively corresponding to an application A, an application B, an application C, and an application D. Referring to FIG. 6C, the mobile phone 100 in FIG. 6C displays the running user interface list in the cascaded manner, and the running user interface list includes preset running user interfaces respectively corresponding to an application A, an application B, and an application C. If the user wants to view the application C, the user may drag the application C to leftward, to enable the application C to be completely displayed on the display screen 110.

Manner 2: The mobile phone 100 completely displays, in the first area of the display screen 110, content included in a first part of the preset running user interfaces included in the running user interface list, and partially displays content included in a second part of the preset running user interfaces included in the running user interface list. In this user interface displaying manner, if the user wants to view the second part of the preset running user interfaces, the user may execute, on the mobile phone 100, a viewing instruction for triggering viewing of the second part of the preset running user interfaces. When detecting the viewing instruction used to trigger viewing of the second part of the preset running user interfaces, the mobile phone 100 completely displays content included in the second part of the preset running user interfaces. The viewing instruction used to trigger viewing of the second part of the preset running user interfaces may be sliding leftward or rightward the preset running user interfaces displayed in the second part, or certainly may be sliding upward or downward the preset running user interfaces displayed in the second part. This is not limited in this application. Referring to FIG. 6D, the mobile phone 100 in FIG. 6D displays, in the foregoing manner 2, preset running user interfaces respectively corresponding to an application A, an application B, and an application C. If the user wants to view the preset running user interface of the application A that is partially displayed, the user may drag the application A rightward, to enable the application A to be completely displayed on the display screen 110 of the mobile phone 100. If the user wants to view a running state of the application C, the user may drag the application C leftward, to enable the application C to be completely displayed on the display screen C of the mobile phone 100.

It should be noted that, the first part of the preset running user interfaces are preset running user interfaces that are included in the running user interface list and that are different from preset running user interfaces included in the second part of the preset running user interfaces, and a sum of a quantity of the running user interfaces of the first part and a quantity of the running user interfaces of the second part may be equal to a quantity of all the preset running user interfaces included in the running user interface list, or certainly may be less than a quantity of all the preset running user interfaces included in the running user interface list. When the sum of the quantity of the preset running user interfaces of the first part and the quantity of the preset running user interfaces of the second part is less than the quantity of all the preset running user interfaces included in the running user interface list, a remaining preset running user interface that is not displayed in the first area may be hidden in the mobile phone 100, and may be displayed through triggering of a viewing instruction. To facilitate viewing by the user, usually only a preset running user interface corresponding to one of the applications is completely displayed in the first area, and a preset running user interface corresponding to another application is partially displayed or hidden in the mobile phone 100, and may be displayed through triggering of an instruction.

In this embodiment of this application, the mobile phone 100 may flexibly select a manner of displaying the one or more preset running user interfaces that respectively correspond to the at least one application, so that the multi-task management function of the mobile phone 100 can be applied to more application scenarios. For example, when the user is concerned with only an application A and an application B included in the at least one application, the mobile phone 100 may completely display, in the first area of the display screen 110, the preset running user interfaces that respectively correspond to the application A and the application B that are included in the one or more preset running user interfaces that respectively correspond to the at least one application, and partially display a preset running user interface corresponding to an application, other than the application A and the application B, included in the one or more preset running user interfaces that respectively correspond to the at least one application. Certainly, the preset running user interface corresponding to the application, other than the application A and the application B, may alternatively be hidden.

In this embodiment of this application, after displaying, in the first area of the display screen 110, the running user interface list including the one or more preset running user interfaces that respectively correspond to the at least one application, the mobile phone 100 may obtain, by using the processor 120 at a preset first period, one or more pieces of next moment running data respectively corresponding to the at least one application, determine, based on the one or more pieces of next moment running data respectively corresponding to the at least one application, one or more next moment preset running user interfaces that respectively correspond to the at least one application, and correspondingly update one or more current preset running user interfaces of the at least one application respectively by using the one or more next moment preset running user interfaces that respectively correspond to the at least one application. Assuming that a music application is run in the background of the mobile phone 100, the processor 120 determines, based on music playing user interface data, music playing lyric content data, music playing audio data, and the like that correspond to the music application, a preset running user interface corresponding to the music application.

According to the foregoing method, the mobile phone 100 may update and display the one or more preset running user interfaces of the at least one application in real time, so that the user can view, based on the multi-task management user interface, a dynamic running process of the at least one application run in the background. For example, when the user is currently opening a reading application for reading, and the user has previously opened the music application for playing a song, if the user wants to view a music playing process, according to the existing multi-task management method, the user needs to switch the music application from being run in the background to being run in the foreground. However, according to the multi-task management method provided in this embodiment of this application, the user can view a dynamic running process of the music application in the first area of the display screen 110 without switching the music application into the foreground for running, so that a waiting time of the user can be reduced. In addition, although the music application is run in the background, an animation effect of a rotating compact disc during music playing makes the user to feel, in terms of visual experience, that the music application is run in the foreground, so that user experience can be improved.

It should be noted that, in an actual application, the preset first period may be flexibly set as required, and the preset first period is not limited in this embodiment of this application.

In this embodiment of this application, the one or more preset running user interfaces that respectively correspond to the at least one application are of a preset shape. The preset shape is not limited in this embodiment of this application. For example, the shape may be a circle or a rectangle, and certainly, may alternatively be another shape. For example, a preset running user interface corresponding to an application of another type may be set as a rectangle, and a preset running user interface corresponding to a music-type application may be set as a circle, so that when the music application runs a playing user interface, a compact disc user interface with which the user is most concerned can be displayed on the circular preset running user interface. In this way, even if the music application is run in the background, an animation effect of a rotating compact disc makes the user feel, in terms of visual experience, that the music application is run in the foreground.

In this embodiment of this application, an operation icon control is displayed on at least one preset running user interface included in the one or more preset running user interfaces that respectively correspond to the at least one application. If detecting that an operation icon control on any one of the at least one preset running user interface is triggered, the mobile phone 100 performs an operation corresponding to the operation icon control on an application corresponding to the preset running user interface on which the operation icon control is triggered. According to the foregoing method, the user can switch and close, by using the multi-task management user interface, an application run in the background, and view a running state of the application run in the background, and the user can also interact, by using the operation icon control, with the application run in the background, so that scenarios to which the multi-task management function of the mobile phone 100 is applicable are further enriched, thereby improving user experience. The operation icon control is used to trigger performing of an operation corresponding to the operation icon control.

It should be noted that an operation icon control displayed on a preset running user interface corresponding to an application is an icon control associated with an operation corresponding to the application. For example, if three operation icon controls are displayed on a preset running user interface corresponding to an application 1, and are respectively an operation icon control a, an operation icon control b, and an operation icon control c, when the operation icon control a, the operation icon control b, and the operation icon control c are triggered, operations corresponding to the application 1 are performed. In addition, if there is no operation icon control associated with a preset running user interface corresponding to an application run in the background, the user can view only a current running state of the application of this type but cannot interact with the application of this type. It should be further noted that, an operation icon control that is most frequently used by the user or some operation icon controls that are most possibly used by the user when an application is run in the background is or are usually selected as an operation icon control or operation icon controls associated with the application.

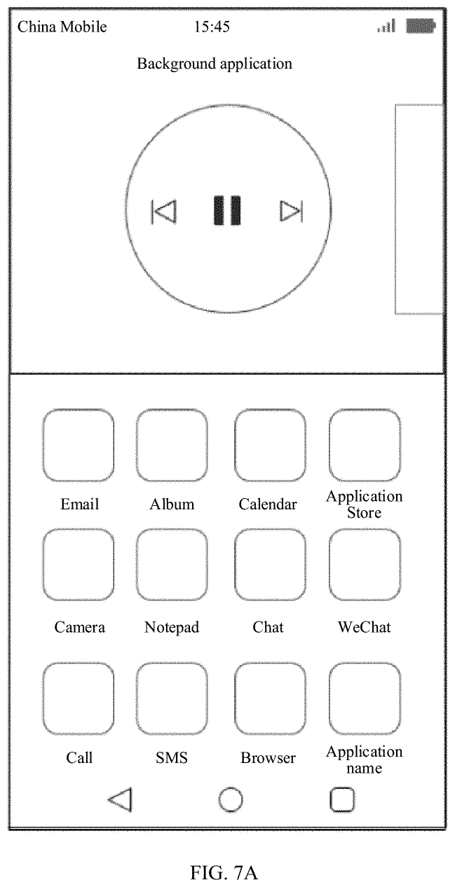

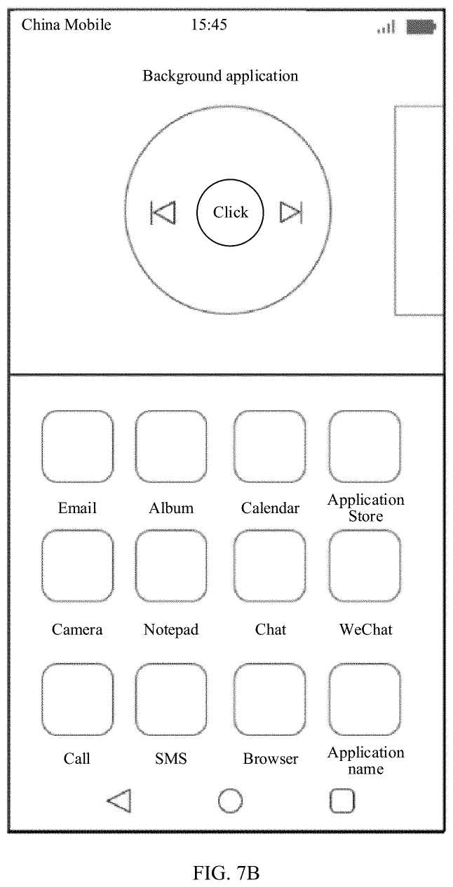

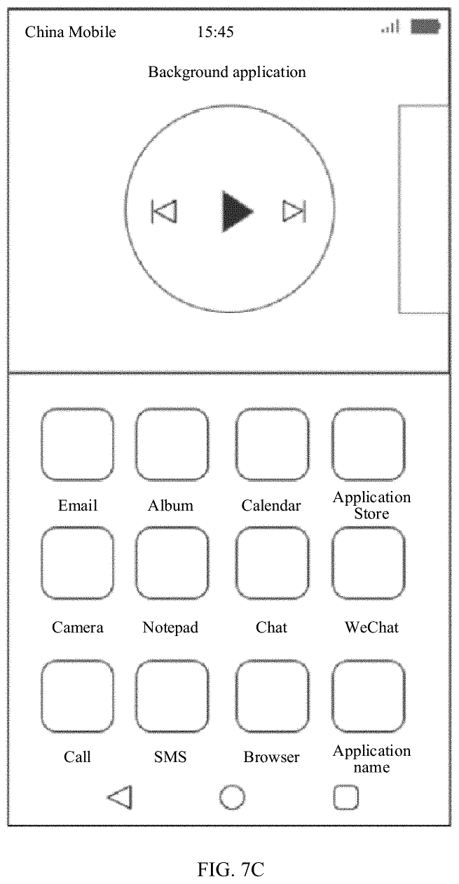

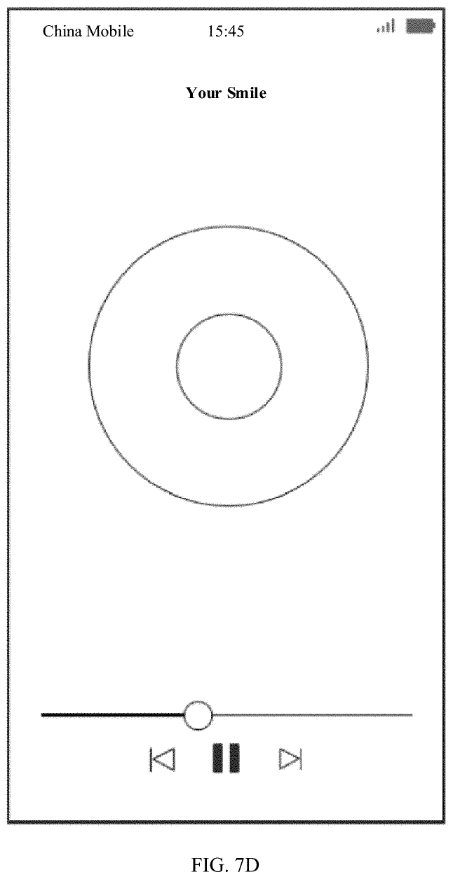

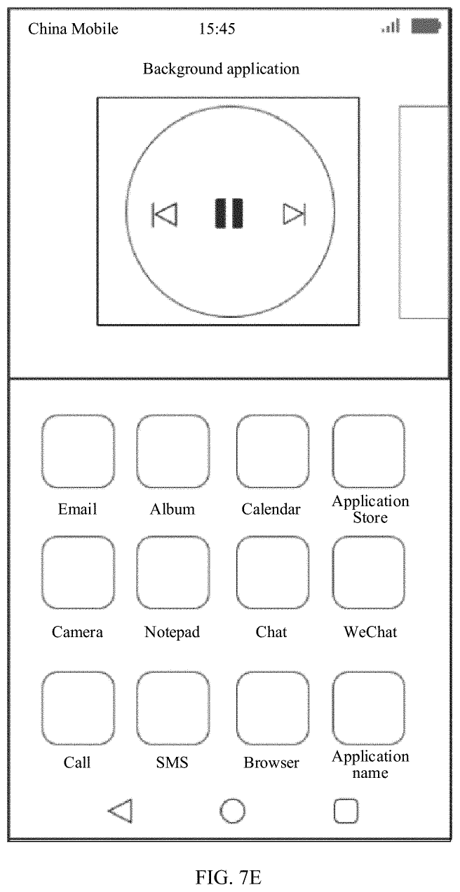

A method for interacting, by the user by using the operation icon control, with an application run in the background is described below in detail by using an example. Referring to FIG. 7A, applications that are run in the background of the mobile phone 100 include a music application and other applications. A preset running user interface corresponding to the music application is a circle. In addition, for aesthetics, a size of the preset running user interface corresponding to the music application is set to a size of a compact disk in a playing user interface of the music application, and preset running user interfaces corresponding to the other applications are rectangles. The mobile phone 100 displays, in Manner 2, the one or more preset running user interfaces that respectively correspond to the at least one application run in the background. Specifically, the preset running user interface corresponding to the music application is completely displayed, one of the applications that are run in the background is partially displayed, and another application run in the background is hidden in the mobile phone 100. In addition, the first area is a partial display area of the display screen 110. Because there is no application run in the foreground in the mobile phone 100 currently, an area on the display screen 110 other than the first area displays the desktop user interface of the mobile phone 100. In addition, an operation icon control for controlling music playing or pausing, an operation icon control for controlling switching to a previous song, and an operation icon control for controlling switching to a next song are displayed on the preset running user interface corresponding to the music application. The user may control, by using the operation icon control “ [symbol] ” for controlling music playing or pausing displayed in FIG. 7A, to play or pause music. Specifically, in FIG. 7A, if the music application is playing music, the user may control, by triggering the operation icon control “ [symbol] ” for controlling music playing or pausing, to pause music playing. FIG. 7B shows a manner of triggering the operation icon control “ [symbol] ” for controlling music playing or pausing. The user may control, by clicking a corresponding trigger control “ [symbol] ”, to control the music application to pause music playing. Certainly, the user may alternatively trigger, by using another gesture or sound, the operation icon control “ [symbol] ” for controlling music playing or pausing. FIG. 7C shows a user interface on which music playing is paused after the user triggers the operation icon control “ [symbol] ” for controlling music playing or pausing. Further, the user may further control, by using the operation icon control “ [symbol] ” for controlling switching to a previous song, to control the music application to switch from playing a current song to playing a previous song, and may further control, by using the operation icon control “ [symbol] ” for controlling switching to a next song, the music application to switch from playing a current song to playing a next song, thereby implementing interaction between the user and the music application run in the background. However, in the existing multi-task management method, if the user wants to interact with the music application run in the background of the mobile phone 100, for example, if the user wants to switch to a previous song, the user needs to switch the music application run in the background into the foreground for running of the mobile phone 100. Referring to FIG. 7D, the music application in FIG. 7D is run in the foreground of the mobile phone 100, and a currently played song is “Your smile”. In this case, an interaction user interface between the user and the mobile phone 100 can display only a running user interface of the music application run in the foreground, and cannot display any other user interface. To be specific, the existing multi-task management method cannot be applied to a scenario in which a plurality of applications are simultaneously used. However, in the multi-task management method provided in this application, an application run in the foreground may occupy a part of the display area of the display screen 110 of the mobile phone 100, the other part of the display area of the display screen 110 of the mobile phone 100 may display an application run in the background, and the user may interact, by using an operation icon control displayed on a preset running user interface corresponding to the application run in the background, with the application run in the background, so that the multi-task management method provided in this application is applicable to a scenario in which the user simultaneously uses a plurality of applications.

In the foregoing implementation process, if the shape of the preset running user interface corresponding to the application run in the background is not preset, the mobile phone 100 displays, by using a shape used in a system by default, the one or more preset running user interfaces that respectively correspond to the at least one application. For example, the shape used in the system by default may be set as a rectangle. Referring to FIG. 7E, in the mobile phone 100, the shape of the preset running user interface corresponding to the application run in the background is not preset, so that the one or more preset running user interfaces that respectively correspond to the at least one application is displayed by using the shape used in the system by default.

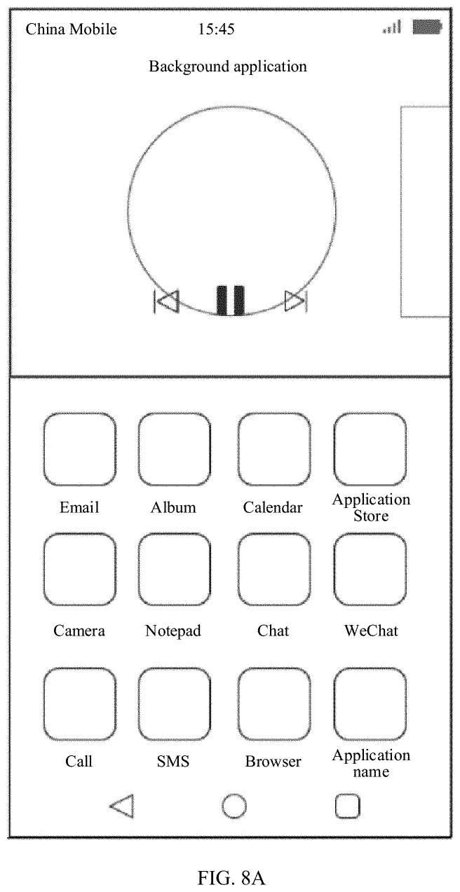

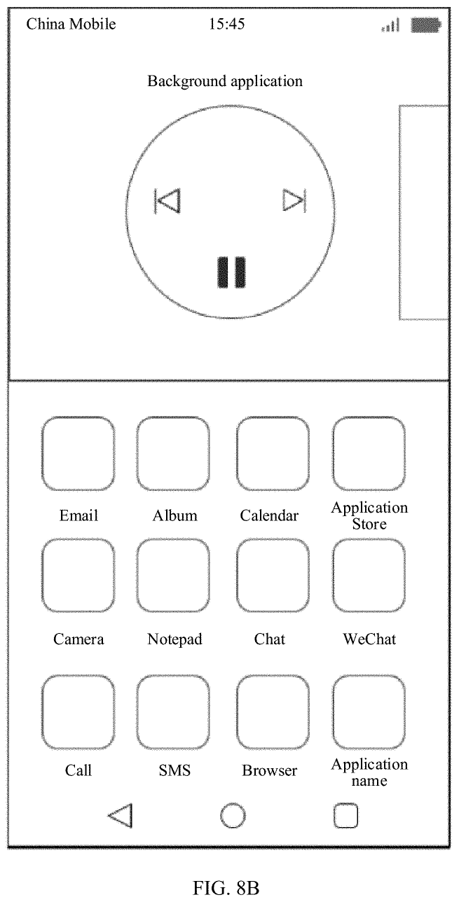

In this embodiment of this application, a location of the operation icon control on the preset running user interface corresponding to the application run in the background is not limited. Specifically, the operation icon control may be displayed at any location on the preset running user interface corresponding to the application run in the background. For example, similar to FIG. 7A and FIG. 7E, the operation icon control is displayed in the middle of the preset running user interface corresponding to the application run in the background, so that user experience is relatively good. Certainly, the operation icon control may alternatively be displayed at another location on the preset running user interface corresponding to the application run in the background. Referring to FIG. 8A and FIG. 8B, in FIG. 8A, the operation icon control is displayed at the bottom of the preset running user interface corresponding to the application run in the background. In FIG. 8B, the operation icon control “ [symbol] ” for controlling music playing or pausing is displayed at the bottom of the preset running user interface corresponding to the application run in the background, and the operation icon control “ [symbol] ” for controlling switching to a previous song and the operation icon control “ [symbol] ” for controlling switching to a next song are displayed in the middle of the preset running user interface corresponding to the application run in the background.

In this embodiment of this application, after the mobile phone 100 displays the running user interface list in the first area of the display screen 110, the user may trigger, by using an instruction, changing of a size of the first area in the display screen 110. When detecting an instruction used to trigger scaling down or up of the first area, the mobile phone 100 scales down or up the size of the first area. According to the method, the user can flexibly change the size of the first area, to adapt to different application scenarios.

It should be noted that the instruction for triggering scaling down or up of the first area is not limited in this embodiment of this application. For example, the instruction for triggering scaling down or up of the first area may be dragging an edge of the first area. Specifically, the mobile phone 100 may set the edge of the first area to be selectable, and the user may scale down or up the size of the first area by selecting and dragging the edge of the first area. If the user does not trigger scaling down or up of the first area, the first area has a default size. For example, the default size of the first area may be a partial display area of the display screen.

In this embodiment of this application, a scale-down or scale-up ratio by which the one or more preset running user interfaces that respectively correspond to the at least one application are scaled down or up with the first area is not limited. In this embodiment of this application, two scaling mechanisms for scaling down or up the one or more preset running user interfaces that respectively correspond to the at least one application with the first area are described below in detail.

One scaling mechanism is uniform scaling. If the mobile phone 100 uses this scaling mechanism, after scaling down the size of the first area, the mobile phone 100 scales down, based on a scale-down ratio of the first area by the scale-down ratio, the one or more preset running user interfaces that respectively correspond to the at least one application and that are displayed in the first area. Alternatively, after scaling up the size of the first area, the mobile phone 100 scales up, based on a scale-up ratio of the first area by the scale-up ratio, the one or more preset running user interfaces that respectively correspond to the at least one application and that are displayed in the first area.

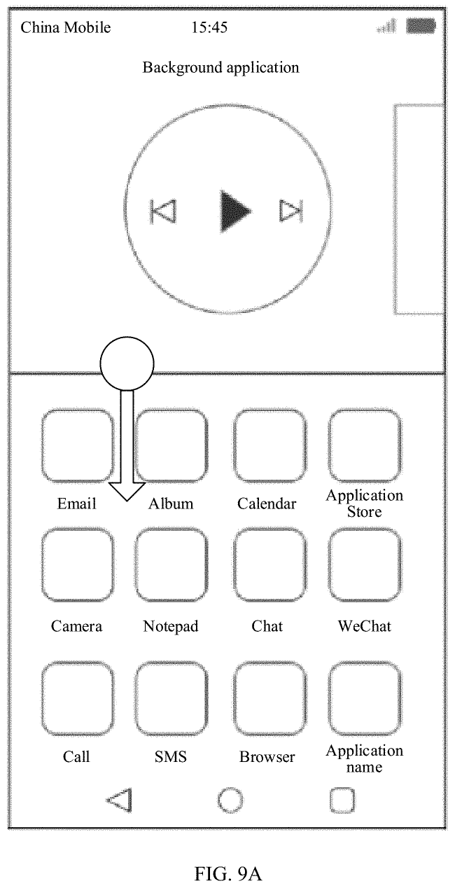

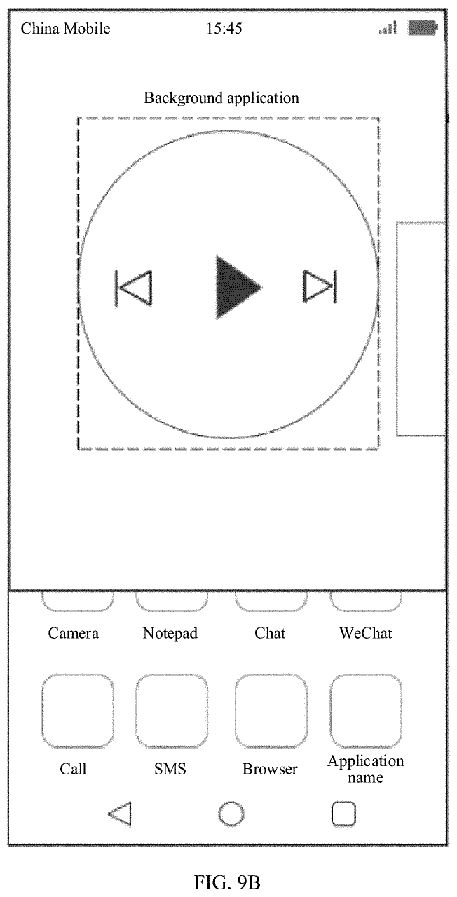

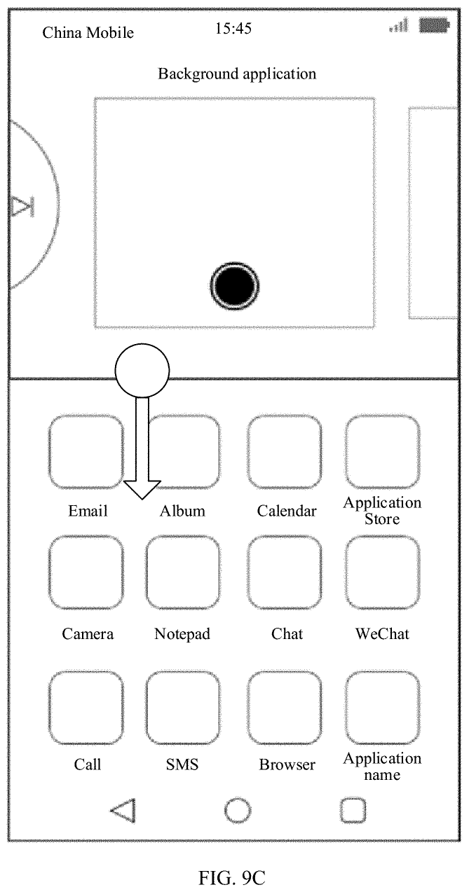

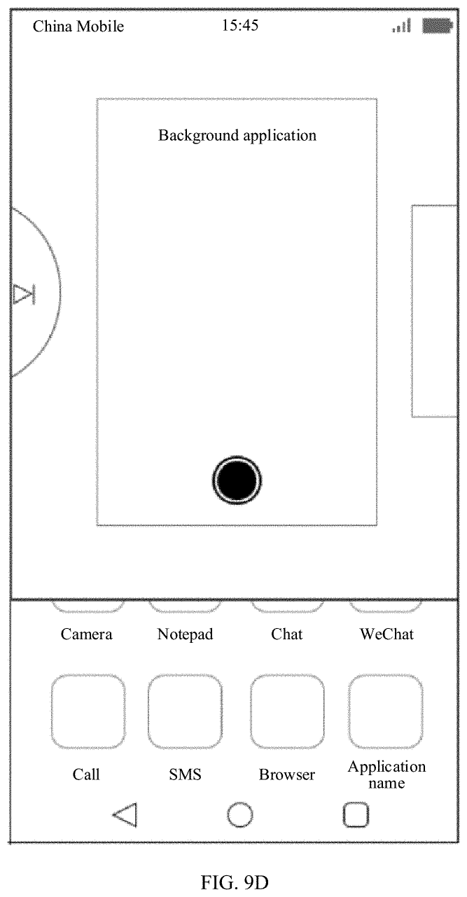

The uniform scaling mechanism is described below by using an example in which the first area is scaled up. Referring to FIG. 9A and FIG. 9B, FIG. 9A is a schematic diagram of triggering scaling up of the first area. FIG. 9B is a schematic diagram after the first area and the preset running user interface that corresponds to the music application and that is displayed in the first area are scaled up. A process of changing from FIG. 9A to FIG. 9B is a process of scaling up the first area and the preset running user interface that corresponds to the music application and that is displayed in the first area. In this process, the user may hold and drag a bottom edge of the first area downward. As shown in FIG. 9A, after the bottom edge of the first area is dragged downward, the scaled-up first area is obtained, as shown in FIG. 9B. It can be learned from FIG. 9B that, the shape of the preset running user interface corresponding to the music application remains unchanged. However, a size of the preset running user interface corresponding to the music application is scaled up with the scaling up of the first area by a corresponding scale-up ratio.

Another scaling mechanism is non-uniform scaling. If the mobile phone 100 uses this scaling mechanism, after the mobile phone 100 scales down the size of the first area, the mobile phone 100 scales down, not based on a scale-down ratio of the first area, the one or more preset running user interfaces that respectively correspond to the at least one application. Alternatively, after the mobile phone 100 scales up the size of the first area, the mobile phone 100 scales up, not based on a scale-up ratio of the first area, the one or more preset running user interfaces that respectively correspond to the at least one application.

The non-uniform scaling mechanism is described below by using an example in which the first area is scaled up. Referring to FIG. 9C and FIG. 9D, FIG. 9C is a schematic diagram before the first area and a preset running user interface that corresponds to a camera application and that is displayed in the first area are scaled up. FIG. 9D is a schematic diagram after the first area and the preset running user interface that corresponds to the camera application and that is displayed in the first area are scaled up. A process of changing from FIG. 9C to FIG. 9D is a process of scaling up the first area and the preset running user interface that corresponds to the camera application and that is displayed in the first area. In this process, the user may hold and drag a bottom edge of the first area downward. As shown in FIG. 9C, after the bottom edge of the first area is dragged downward, the scaled-up first area is obtained, as shown in FIG. 9D. It can be learned from FIG. 9D that, a shape of the preset running user interface corresponding to the camera application is scaled up with the scaling up of the first area. However, a scale-up ratio of the shape of the preset running user interface corresponding to the camera application is not a scale-up ratio of the first area. With extension of the first area, a distance between a user interface on which the camera application is displayed and an edge of a window remains unchanged, and the shape is extended with extension of the window, to display more content.

According to the foregoing method, the user may scale down or up, as required, the one or more preset running user interfaces that respectively correspond to the at least one application. For example, if the user wants to view more content related to the running user interface, the user may scale up the size of the first area, to further scale up the preset running user interface corresponding to the application. Compared with the existing multi-task management method in which applications that are run in the background are displayed in an entire area of the display screen of the terminal device, in this embodiment of this application, the user can flexibly adjust the size of the first area displaying the one or more preset running user interfaces that respectively correspond to the at least one application, to adapt to different application scenarios, thereby improving user experience.

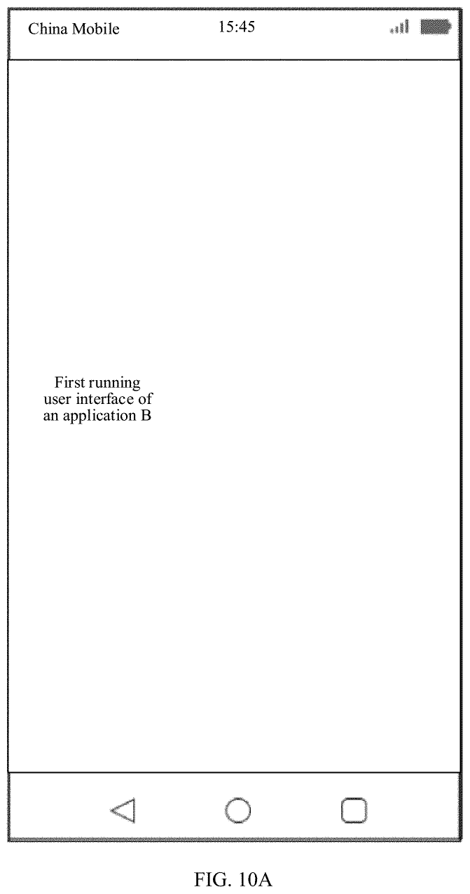

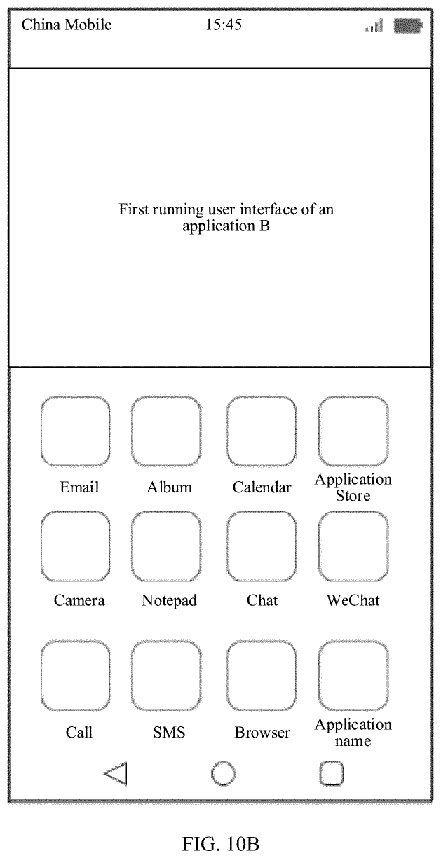

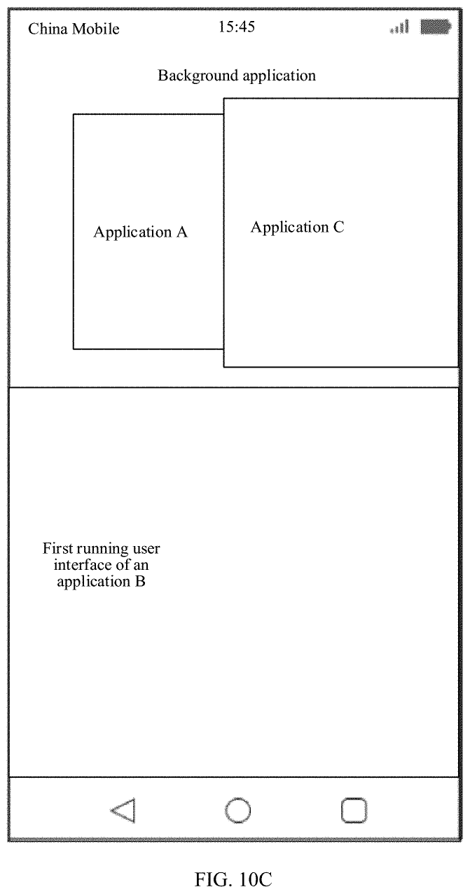

In this embodiment of this application, after the mobile phone 100 displays the running user interface list in the first area of the display screen 110, if detecting a trigger instruction used to trigger running of any one of the at least one application in the foreground, the mobile phone 100 switches the application whose running in the foreground is triggered into the foreground for running, and displays, in an entire area of the display screen 110, the first area of the display screen 110, or the second area of the display screen 110, a first running user interface corresponding to the application that is switched into the foreground for running. FIG. 10A, FIG. 10B, and FIG. 10C are schematic diagrams in which the application B in FIG. 6C is switched into the foreground for running. In FIG. 10A, a first running user interface corresponding to the application B is displayed in the entire area of the display screen 110. In FIG. 10B, a first running user interface corresponding to the application B is displayed in the first area of the display screen 110. In FIG. 10C, a first running user interface corresponding to the application B is displayed in the second area of the display screen 110. According to the foregoing method, the user may conveniently switch, by using the running user interface list, an application from being run in the background to being run in the foreground, and the application may be displayed in the entire area of the display screen or may be displayed in the first area or the second area of the display screen, to satisfy various requirements of the user, so that user experience is improved.

It should be noted that, the foregoing first running user interface is different from the preset running user interface, and the first running user interface is not a running user interface customized by the user for the application but is a conventional running user interface of the application when the application is run in the foreground. Specifically, the preset running user interface may display partial content during running of the application as set by the user, and the first running user interface displays entire content during running of the application.

In this embodiment of this application, the multi-task management method provided in this application and how a user interacting with the terminal device (for example, the mobile phone 100) uses the multi-task management method provided in this application are mainly described above in detail. The multi-task management method in this application is further described below for another type of users, namely, research and development personnel, with reference to the accompanying drawings.

In this embodiment of this application, for the multi-task management function of the terminal device, the following interfaces are provided for research and development personnel:

(1) An Interface for a User Interface that is of an Application Run in the Background and that is Displayed on the Multi-Task Management User Interface.

The research and development personnel may define, by using the interface, a user interface that is of an application run in the background and that is displayed on the multi-task management user interface. Specifically, the research and development personnel may select a user interface of the application to be fixedly displayed on the multi-task management user interface of the terminal device. If the research and development personnel do not define, by using the interface, the user interface that is of the application run in the background and that is displayed on the multi-task management user interface, the terminal device displays, by default, a screenshot of a last frame of image obtained when each application is switched into the background or a home page user interface of the application.

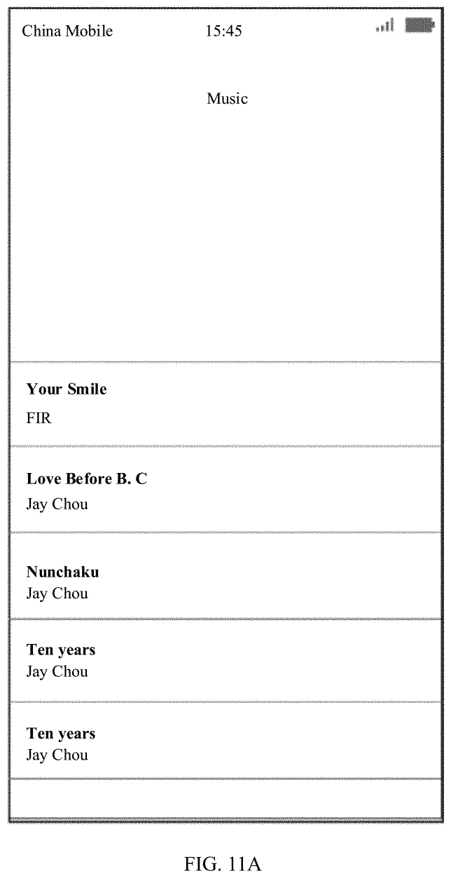

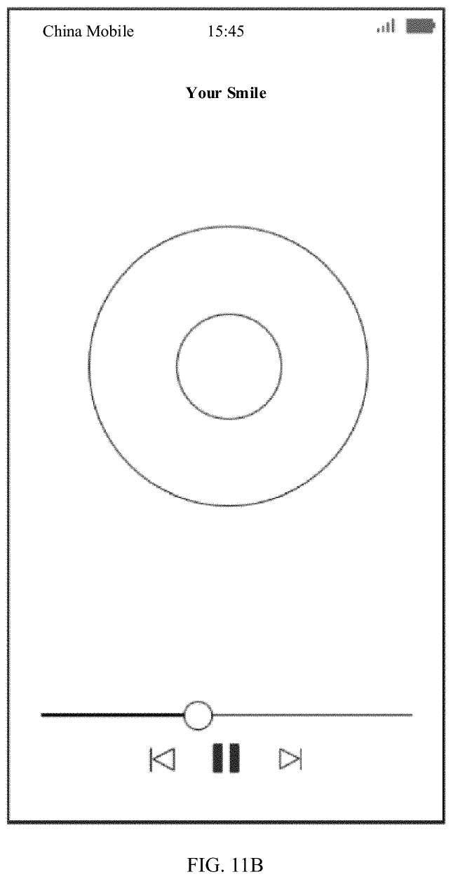

The foregoing interface is described below by using a music application as an example. The music application includes a plurality of user interfaces, for example, a music list user interface, a music playing user interface, and a home page user interface of the music application. FIG. 11A shows the music list user interface, and the user interface displays songs included in the music application. FIG. 11B shows the music playing user interface, and the user interface displays a song that is played currently. When the music application is run in the background, the music playing user interface is usually more valuable for users. Therefore, the research and development personnel may define, by using the foregoing interface, the music playing user interface as a user interface that is of the music application and that is displayed on the multi-task management user interface. Certainly, the research and development personnel may alternatively define, by using the foregoing interface, the music list user interface as a user interface that is of the music application and that is displayed on the multi-task management user interface. However, if the research and development personnel do not define, by using the foregoing interface, a user interface that is of the music application and that is displayed on the multi-task management user interface, the terminal device selects a default user interface, such as a screenshot of a last frame of image obtained when the music application is switched into the background or the home page user interface of the music application, for displaying on the multi-task management user interface.

(2) An Interface for Presenting a Shape of a User Interface that is of an Application Run in the Background and that is Displayed on the Multi-Task Management User Interface.

The research and development personnel may define, by using the interface, the shape of the user interface that is of the application run in the background and that is displayed on the multi-task management user interface. Content that is of the displayed user interface corresponding to the application and that exceeds the shape is not displayed. If the research and development personnel do not define, by using the interface, the shape of the user interface that is of the application run in the background and that is displayed on the multi-task management user interface, the terminal device displays, by using a preset default shape, the user interface that is of the application run in the background and that is displayed on the multi-task management user interface. Optionally, the preset default shape may be a rectangle or a circle, or certainly may be another shape. For example, assuming that research and development personnel already define, by using the interface in (1), the music playing user interface as the user interface that is of the music application and that is displayed on the multi-task management user interface, the research and development personnel may further define, by using the interface in (2), a shape of the user interface that is of the music application and that is displayed on the multi-task management user interface as a circle. Because the user is most concerned with a compact disk in a center of the music playing user interface, the research and development personnel may set the circle defined by using the interface in (2) to have a size of the compact disk, to improve user experience.

(3) An Interface for an Operation Icon Control Corresponding to an Application Run in the Background.

The research and development personnel may define, by using the interface, the operation icon control corresponding to the application run in the background, the operation icon control is associated with an operation of the application, and the associated operation may be an operation that is relatively frequently used by the user. The research and development personnel need to provide a corresponding icon to the terminal device by using the interface. If the research and development personnel do not define, by using the interface, the operation icon control corresponding to the application run in the background, the terminal device does not define the operation icon control for the application; and consequently, the user cannot interact with the application run in the background, and can perform only a viewing or switching operation.

(4) An Interface for a Display Location that is of an Operation Icon Control Corresponding to the Application Run in the Background and that is on a Display User Interface of the Application.

After defining, by using the interface in (3), the operation icon control corresponding to the application run in the background, the research and development personnel may further define, by using the interface in (4), the display location that is of the operation icon control corresponding to the application run in the background and that is on the display user interface of the application. Specifically, the operation icon control may be displayed at any location on the display user interface of the application, and the research and development personnel may select a location at which user experience is optimal. If the research and development personnel define, by using the interface in (3), the operation icon control corresponding to the application run in the background, but do not define, by using the interface in (4), the display location that is of the operation icon control corresponding to the application run in the background and that is on the display user interface of the application, the terminal device displays the operation icon control at a preset default location, and the preset default location may be a location at which user experience is relatively good.

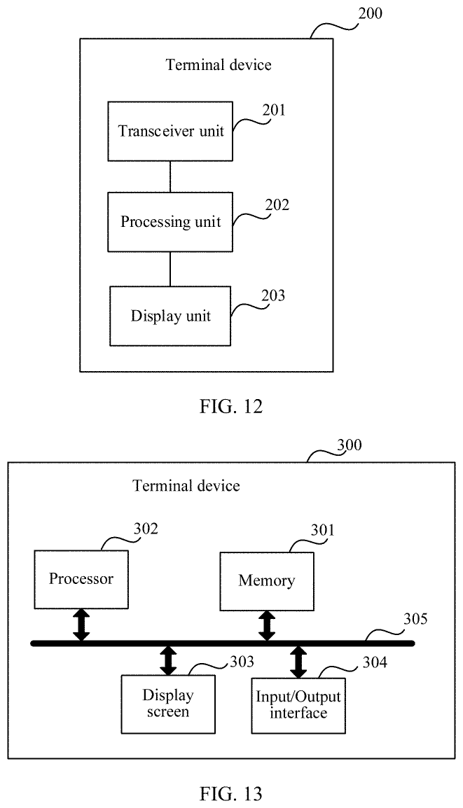

Based on a same inventive concept as that of the method embodiment, an embodiment of this application further provides a terminal device 200. The terminal device 200 is specifically configured to implement the method described in the embodiment in FIG. 4. A structure of the terminal device 200 is shown in FIG. 12, and includes a transceiver unit 201, a processing unit 202, and a display unit 203.

The transceiver unit 201 is configured to receive a trigger instruction used to trigger display of one or more preset running user interfaces that respectively correspond to at least one application run in a background.

The processing unit 202 is configured to: after the transceiver unit 201 receives the trigger instruction used to trigger display of the one or more preset running user interfaces that respectively correspond to at least one application run in the background, detect the trigger instruction; and after the processing unit 202 detects the trigger instruction, display a running user interface list in a first area of the display unit 203, where the running user interface list includes the one or more preset running user interfaces that respectively correspond to at least one application.

In a possible implementation, an operation icon control is displayed on at least one preset running user interface included in the one or more preset running user interfaces that respectively correspond to the at least one application, and the operation icon control is used to trigger performing of an operation corresponding to the operation icon control.

With reference to the foregoing implementation, after the processing unit 202 controls displaying the running user interface list in the first area of the display unit 203, the processing unit 202 may detect a trigger instruction that is received by the transceiver unit 201 and that is used to trigger the operation icon control. If detecting that an operation icon control on any one of the at least one preset running user interface is triggered, the processing unit 202 performs an operation corresponding to the operation icon control on an application corresponding to the preset running user interface on which the operation icon control is triggered.

In a possible implementation, the processing unit 202 is further configured to:

control the display unit 203 to display, in a second area, a running user interface of an application currently run in a foreground or display a desktop user interface of the terminal device 200. The second area of the display unit 203 may be an area of the display unit 203 other than the first area.

In a possible implementation, the one or more preset running user interfaces that respectively correspond to the at least one application are of a preset shape. The preset shape is not limited in this embodiment of this application. For example, the preset shape may be a circle, a rectangle, or the like.

In a possible implementation, the processing unit 202 is further configured to: after controlling displaying the running user interface list in the first area of the display unit 203, if detecting an instruction that is received by using the transceiver unit 201 and that is used to trigger scaling down or up of the first area, scale down or up a size of the first area.

In a possible implementation, the processing unit 202 scales down or up the size of the first area in the following manner: scaling down the size of the first area, and scaling down, based on a scale-down ratio of the first area by the scale-down ratio, the one or more preset running user interfaces that respectively correspond to the at least one application and that are displayed in the first area; or scaling up the size of the first area, and scaling up, based on a scale-up ratio of the first area by the scale-up ratio, the one or more preset running user interfaces that respectively correspond to the at least one application and that are displayed in the first area.

In this embodiment of this application, the processing unit 202 may control displaying the running user interface list in the first area of the display unit 203 in a plurality of manners. In a possible design, the processing unit 202 controls displaying the running user interface list in the first area of the display unit 203 in a tiled or cascaded manner. In another possible design, the processing unit 202 controls completely displaying, in the first area of the display unit 203, content included in a first part of the preset running user interfaces included in the running user interface list, and partially displaying content included in a second part of the preset running user interfaces included in the running user interface list, where the first part of the preset running user interfaces is different from the second part of the preset running user interfaces.

It should be noted that, a sum of a quantity of the running user interfaces of the first part and a quantity of the running user interfaces of the second part may be equal to a quantity of all the preset running user interfaces included in the running user interface list, or certainly may be less than a quantity of all the preset running user interfaces included in the running user interface list. When the sum of the quantity of the preset running user interfaces of the first part and the quantity of the preset running user interfaces of the second part is less than the quantity of all the preset running user interfaces included in the running user interface list, a remaining preset running user interface that is not displayed in the first area may be hidden in the terminal device 200, and may be displayed through triggering of an instruction.

In a possible implementation, when detecting a viewing instruction used to trigger viewing of the second part of the preset running user interfaces, the processing unit 202 completely displays the content included in the second part of the preset running user interfaces. The user may conveniently switch the partially displayed preset running user interfaces to the completely displayed preset running user interfaces by using the trigger instruction, to satisfy a requirement of the user for complete display of the preset running user interface.

A viewing instruction for triggering viewing of a partially displayed preset running user interface may be sliding the partially displayed preset running user interface leftward or rightward or sliding the partially displayed preset running user interface upward or downward. This is not limited in this embodiment of this application.

In a possible implementation, the processing unit 202 is further configured to: after controlling displaying the running user interface list in the first area of the display unit 203, if detecting a trigger instruction that is received by using the transceiver unit 201 and that is used to trigger running of any application of the at least one application in the foreground, switch the application into the foreground for running; and display, in an entire area of the display unit 203, the first area of the display unit 203, or the second area of the display unit 203, a first running user interface corresponding to the application that is switched into the foreground for running.

It should be noted that, the first running user interface is different from the preset running user interface, and the first running user interface is not a running user interface customized by the user for the application but is a conventional running user interface of the application when the application is run in the foreground. Specifically, the preset running user interface may display partial content during running of the application as set by the user, and the first running user interface displays entire content during running of the application.

In this embodiment of the present invention, the unit division is an example, is merely logical function division, and may be other division in an actual implementation. In addition, functional units in each embodiment of this application may be integrated into one processor or may exist alone physically. Alternatively, two or more units may be integrated into one unit. The foregoing integrated unit may be implemented in a form of hardware, or may be implemented in a form of a software functional module.

When the integrated unit is implemented in the form of a software functional unit and sold or used as an independent product, the integrated unit may be stored in a computer-readable storage medium. Based on such an understanding, the technical solutions of this application essentially, or the part contributing to the prior art, or all or some of the technical solutions may be implemented in the form of a software product. The software product is stored in a storage medium and includes several instructions for instructing a terminal device (which may be a personal computer, a mobile phone, a television, or the like) or a processor (processor) to perform all or some of the steps of the methods in the embodiments of this application. The foregoing storage medium includes: any medium that can store program code, such as a USB flash drive, a removable hard disk, a read-only memory (read-only memory, ROM), a random access memory (random access memory, RAM), a magnetic disk, or an optical disc.

Based on the foregoing embodiment, an embodiment of this application further provides a terminal device 300. The terminal device 300 is configured to implement the embodiment shown in FIG. 4. Referring to FIG. 13, the terminal device 300 may include a memory 301, a processor 302, a display screen 303, and an input/output interface 304.

The memory 301 is configured to store a computer program executed by the processor 302. The memory 301 may mainly include a program storage area and a data storage area. The program storage area may store an operating system, an application program required by at least one function, and the like. The data storage area may store data created based on use of the terminal device 300, and the like. The processor 302 may be a central processing unit (central processing unit, CPU), a digital processing unit, or the like. The display screen 303 is configured to display information input by a user or information provided for the user. Optionally, the display screen 303 may be configured in a form such as a liquid crystal display (liquid crystal display, LCD) or an OLED (organic light-emitting diode, organic light-emitting diode).

A specific connection medium between the memory 301, the processor 302, the display screen 303, and the input/output interface 304 is not limited in this embodiment of this application. In this embodiment of this application, in FIG. 11, the memory 301, the processor 302, the display screen 303, and the input/output interface 304 are connected by using a bus 305. The bus 305 is represented by using a thick line in FIG. 11, and a connection manner between other components is merely described as an example, and is not limited thereto. The bus 305 may be classified into an address bus, a data bus, a control bus, and the like. For ease of representation, the bus is represented by using only one thick line in FIG. 13, but this does not indicate that there is only one bus or only one type of bus.

The memory 301 may be a volatile memory (volatile memory), for example, a random access memory (random-access memory, RAM). The memory 301 may alternatively be anon-volatile memory (non-volatile memory), for example, a read-only memory, a flash memory (flash memory), a hard disk drive (hard disk drive, HDD), or a solid-state drive (solid-state drive, SSD). The memory 301 is alternatively any other medium that can carry or store expected program code in a form of an instruction or a data structure and that can be accessed by a computer, but is not limited thereto. The memory 301 may be a combination of the foregoing memories.

The input/output interface 304 is configured to receive a trigger instruction used to trigger display of one or more preset running user interfaces that respectively correspond to at least one application run in a background of the terminal device 300.

The processor 302 is configured to implement the multi-task management method shown in FIG. 4. The method includes:

The processor 302 is configured to invoke the computer program stored in the memory 301 to perform the following operation: after the input/output interface 304 receives the trigger instruction, detecting, by the processor 302, the trigger instruction that is input by using the input/output interface 304, and displaying a running user interface list in a first area of the display screen 303, where the running user interface list includes the one or more preset running user interfaces that respectively correspond to the at least one application.

In a possible implementation, an operation icon control is displayed on at least one preset running user interface included in the one or more preset running user interfaces that respectively correspond to the at least one application, and the operation icon control is used to trigger performing of an operation corresponding to the operation icon control. With reference to the implementation, the input/output interface 304 is further configured to receive an instruction for triggering an operation icon control; and the processor 302 is further configured to: after the display screen 303 displays the running user interface list in the first area, when detecting an instruction that is input by using the input/output interface 304 and that is used to trigger an operation icon control on any one of the at least one preset running user interface, perform an operation corresponding to the operation icon control on an application corresponding to the preset running user interface on which the operation icon control is triggered.

In a possible implementation, the processor 302 is further configured to display, in a second area of the display screen 303, a running user interface of an application currently run in a foreground of the terminal device 300 or display a desktop user interface of the terminal device 300. The second area of the display screen 303 may be an area on the display screen 303 other than the first area.

In this embodiment of this application, the one or more preset running user interfaces that respectively correspond to the at least one application are of a preset shape. The preset shape is not limited in this embodiment of this application. For example, the preset shape may be a circle, a rectangle, or the like.

In a possible implementation, the processor 302 is further configured to: after displaying the running user interface list in the first area of the display screen 303, if detecting an instruction that is input by using the input/output interface 304 and that is used to trigger scaling down or up of the first area, scale down a size of the first area or scale up a size of the first area of the display screen 303.

In a possible implementation, the processor 302 scales down or up the size of the first area of the display screen 303 specifically in the following manner: scaling down the size of the first area, and scaling down, based on a scale-down ratio of the first area by the scale-down ratio, the one or more preset running user interfaces that respectively correspond to the at least one application and that are displayed in the first area; or scaling up the size of the first area, and scaling up, based on a scale-up ratio of the first area by the scale-up ratio, the one or more preset running user interfaces that respectively correspond to the at least one application and that are displayed in the first area.

In this embodiment of this application, the processor 302 may display the running user interface list in the first area of the display screen 303 in a plurality of manners. In a possible implementation, the processor 302 displays the running user interface list in the first area of the display screen 303 in a tiled or cascaded manner. In another possible implementation, the processor 302 completely displays, in the first area of the display screen 303, content included in a first part of the preset running user interfaces included in the running user interface list, and partially displays content included in a second part of the preset running user interfaces included in the running user interface list, where the first part of the preset running user interfaces is different from the second part of the preset running user interfaces.

It should be noted that, a sum of a quantity of the running user interfaces of the first part and a quantity of the running user interfaces of the second part may be equal to a quantity of all the preset running user interfaces included in the running user interface list, or certainly may be less than a quantity of all the preset running user interfaces included in the running user interface list. When the sum of the quantity of the preset running user interfaces of the first part and the quantity of the preset running user interfaces of the second part is less than the quantity of all the preset running user interfaces included in the running user interface list, a remaining preset running user interface that is not displayed in the first area may be hidden in the terminal device, and may be displayed through triggering of an instruction.

In a possible implementation, the processor 302 is further configured to: when detecting a viewing instruction that is input by using the input/output interface 304 and that is used to trigger viewing of the second part of the preset running user interfaces, completely display the content included in the second part of the preset running user interfaces.

In a possible implementation, the processor 302 is further configured to:

after displaying the running user interface list in the first area of the display screen 303, if detecting a trigger instruction that is input by using the input/output interface 304 and that is used to trigger running of any application of the at least one application in the foreground, switch the application into the foreground for running; and display, in an entire area of the display screen 303, the first area of the display screen 303, or the second area of the display screen 303, a first running user interface corresponding to the application that is switched into the foreground for running.

It should be noted that, the first running user interface is different from the preset running user interface, and the first running user interface is not a running user interface customized by the user for the application but is a conventional running user interface of the application when the application is run in the foreground. Specifically, the preset running user interface may display partial content during running of the application as set by the user, and the first running user interface displays entire content during running of the application.

An embodiment of the present invention further provides a computer-readable storage medium. The computer-readable storage medium stores a computer software instruction that needs to be executed by the foregoing processor, and includes a program that needs to be executed by the foregoing processor.

An embodiment of this application further provides a computer program product. The computer program product stores an instruction, and when the instruction is run on a computer, the computer is enabled to perform the method according to any one of the first aspect or the possible designs of the first aspect.

In conclusion, the embodiments of this application provide a multi-task management method and a terminal device. In the method, a terminal device displays, on a multi-task management user interface, one or more preset running user interfaces that respectively correspond to at least one application run in a background. Compared with a prior-art method in which the terminal device displays, on the multi-task management user interface, a screenshot of a last frame of image obtained when the at least one application is switched into the background, according to the method provided in the embodiments of this application, a user can close or switch, by using the multi-task management user interface, an application run in the background, and can also view, by using the multi-task management user interface, a preset running state of the application run in the background, so that the multi-task management method can be relatively well applied to application scenarios in addition to switching or closing the application, and the multi-task management method has a relatively high practical value for a scenario in which a user needs to control a running state of a background application.

Persons skilled in the art should understand that the embodiments of this application may be provided as a method, a system, or a computer program product. Therefore, this application may use a form of hardware only embodiments, software only embodiments, or embodiments with a combination of software and hardware. Moreover, this application may use a form of a computer program product that is implemented on one or more computer-usable storage media (including but not limited to a magnetic disk storage, a CD-ROM, an optical memory, and the like) that include computer usable program code.

This application is described with reference to the flowcharts and/or block diagrams of the method, the device (system), and the computer program product according to the embodiments of this application. It should be understood that computer program instructions may be used to implement each procedure and/or each block in the flowcharts and/or the block diagrams and a combination of a procedure and/or a block in the flowcharts and/or the block diagrams. These computer program instructions may be provided for a general-purpose computer, a special-purpose computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions may be stored in a computer readable memory that can instruct the computer or the another programmable data processing device to work in a specific manner, so that the instructions stored in the computer readable memory generate an artifact that includes an instruction apparatus. The instruction apparatus implements a specific function in one or more procedures in the flowcharts and/or in one or more blocks in the block diagrams.

These computer program instructions may alternatively be loaded onto the computer or the another programmable data processing device, so that a series of operations and steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

Although some possible embodiments of this application have been described, persons skilled in the art can make additional changes and modifications to these embodiments once they learn the basic inventive concept. Therefore, the appended claims are construed as to cover the embodiments of this application and all changes and modifications falling within the scope of this application.

Obviously, persons skilled in the art can make various modifications and variations to this application without departing from the spirit and scope of this application. This application is intended to cover these modifications and variations of this application provided that they fall within the scope of protection defined by the following claims and their equivalent technologies.

What is claimed is:

1. A multi-task management method, comprising:
detecting, by a terminal device, a trigger instruction used to trigger display of one or more preset running user interfaces that respectively correspond to at least one application run in a background; and
displaying, by the terminal device, a running user interface list in a first area of a display screen after detecting the trigger instruction, wherein the running user interface list comprises the one or more preset running user interfaces that respectively correspond to the at least one application.

2. The method according to claim 1, wherein an operation icon control is displayed on at least one preset running user interface comprised in the one or more preset running user interfaces that respectively correspond to the at least one application, and the operation icon control is used to trigger performing of an operation corresponding to the operation icon control; and
after the displaying, by the terminal device, the running user interface list in the first area of the display screen, the method further comprises:
performing, by the terminal device when detecting that the operation icon control on any one of the at least one preset running user interface is triggered, an operation corresponding to the operation icon control on an application corresponding to the preset running user interface on which the operation icon control is triggered.

3. The method according to claim 1, further comprising:
displaying, by the terminal device in a second area of the display screen, a running user interface of an application currently run in a foreground or displaying a desktop user interface of the terminal device.

4. The method according to claim 1, wherein the one or more preset running user interfaces that respectively correspond to the at least one application are of a preset shape.

5. The method according to claim 1, wherein after the displaying, by the terminal device, the running user interface list in the first area of the display screen, the method further comprises:
scaling down or up, by the terminal device, a size of the first area when detecting an instruction used to trigger scaling down or up of the first area.

6. The method according to claim 5, wherein the scaling down or up, by the terminal device, the size of the first area comprises:
scaling down, by the terminal device, the size of the first area, and scaling down, based on a scale-down ratio of the first area by the scale-down ratio, the one or more preset running user interfaces that respectively correspond to the at least one application and that are displayed in the first area; or
scaling up, by the terminal device, the size of the first area, and scaling up, based on a scale-up ratio of the first area by the scale-up ratio, the one or more preset running user interfaces that respectively correspond to the at least one application and that are displayed in the first area.

7. The method according to claim 1, wherein the displaying, by the terminal device, the running user interface list in the first area of the display screen comprises:
displaying, by the terminal device, the running user interface list in the first area of the display screen in a tiled or cascaded manner.

8. The method according to claim 1, wherein the displaying, by the terminal device, the running user interface list in the first area of the display screen comprises:
completely displaying, by the terminal device in the first area of the display screen, content comprised in a first part of the preset running user interfaces comprised in the running user interface list, and partially displaying content comprised in a second part of the preset running user interfaces comprised in the running user interface list, wherein the first part of the preset running user interfaces is different from the second part of the preset running user interfaces.

9. The method according to claim 8, further comprising:
completely displaying, by the terminal device when detecting a viewing instruction used to trigger viewing of the second part of the preset running user interfaces, the content comprised in the second part of the preset running user interfaces.

10. The method according to claim 2, wherein after the displaying, by the terminal device, the running user interface list in the first area of the display screen, the method further comprises:
switching, by the terminal device when detecting a trigger instruction used to trigger running of any application of the at least one application in a foreground, the application into the foreground for running; and displaying, in an entire area of the display screen, the first area of the display screen, or the second area of the display screen, a first running user interface corresponding to the application that is switched into the foreground for running.

11. A terminal device, comprising a processor, a memory, a display screen, and an input/output interface, wherein
the memory is configured to store a computer program;
the display screen is configured to display information;
the input/output interface is configured to receive a trigger instruction used to trigger display of one or more preset running user interfaces that respectively correspond to at least one application run in a background of the terminal device; and
the processor is configured to invoke the computer program stored in the memory to perform the following step:
after the input/output interface receives the trigger instruction, detecting, by the processor, the trigger instruction input by using the input/output interface, and displaying a running user interface list in a first area of the display screen, wherein the running user interface list comprises the one or more preset running user interfaces that respectively correspond to the at least one application.

12. The terminal device according to claim 11, wherein an operation icon control is displayed on at least one preset running user interface comprised in the one or more preset running user interfaces that respectively correspond to the at least one application, and the operation icon control is used to trigger performing of an operation corresponding to the operation icon control;
the input/output interface is further configured to receive an instruction for triggering the operation icon control; and
the processor is further configured to: after displaying the running user interface list in the first area of the display screen, when detecting an instruction that is input by using the input/output interface and that is used to trigger the operation icon control on any one of the at least one preset running user interface, perform an operation corresponding to the operation icon control on an application corresponding to the preset running user interface on which the operation icon control is triggered.

13. The terminal device according to claim 11, wherein the processor is further configured to display, in a second area of the display screen, a running user interface of an application currently run in a foreground of the terminal device or displaying a desktop user interface of the terminal device.

14. The terminal device according to claim 11, wherein the one or more preset running user interfaces that respectively correspond to the at least one application are of a preset shape.

15. The terminal device according to claim 11, wherein the processor is further configured to:
after displaying the running user interface list in the first area of the display screen, if detecting an instruction that is input by using the input/output interface and that is used to trigger scaling up or scaling down of the first area, scale down or up a size of the first area of the display screen.

16. The terminal device according to claim 15, wherein when scaling down or up the size of the first area of the display screen, the processor is specifically configured to:
scale down the size of the first area, and scaling down, based on a scale-down ratio of the first area by the scale-down ratio, the one or more preset running user interfaces that respectively correspond to the at least one application and that are displayed in the first area; or
scale up the size of the first area, and scaling up, based on a scale-up ratio of the first area by the scale-up ratio, the one or more preset running user interfaces that respectively correspond to the at least one application and that are displayed in the first area.

17. The terminal device according to claim 11, wherein after displaying the running user interface list in the first area of the display screen, the terminal device is specifically configured to:
display the running user interface list in the first area of the display screen in a tiled or cascaded manner.

18. The terminal device according to claim 11, wherein after displaying the running user interface list in the first area of the display screen, the terminal device is specifically configured to:
completely display, in the first area of the display screen, content comprised in a first part of the preset running user interfaces comprised in the running user interface list, and partially display content comprised in a second part of the preset running user interfaces comprised in the running user interface list, wherein the first part of the preset running user interfaces is different from the second part of the preset running user interfaces.

19. The terminal device according to claim 18, wherein the processor is further configured to: when detecting a viewing instruction that is input by using the input/output interface and that is used to trigger viewing of the second part of the preset running user interfaces, completely display content comprised in the second part of the preset running user interfaces.

20. The terminal device according to claim 12, wherein the processor is further configured to:
after displaying the running user interface list in the first area of the display screen, if detecting a trigger instruction that is input by using the input/output interface and that is used to trigger running of any application of the at least one application in a foreground, switch the application into the foreground for running; and display, in an entire area of the display screen, the first area of the display screen, or the second area of the display screen, a first running user interface corresponding to the application that is switched into the foreground for running.
